(19) United States
(12) Patent Application Publication
(10) Pub. No.: US 2010/0056201 A1
(43) Pub. Date: Mar. 4, 2010

(54) SEMICONDUCTOR INTEGRATED CIRCUIT AND CIRCUIT OPERATION METHOD

(75) Inventors: Yukinori AKAMINE, Kokubunji (JP); Kazuhiko Hikasa, Hamura (JP); Yuki Okada, Maebashi (JP); Satoru Yamamoto, Ibaraki (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 12/543,504

(22) Filed: Aug. 19, 2009

(30) Foreign Application Priority Data
Aug. 29, 2008 (JP) 2008-220651

(51) Int. Cl. H04M 1/00; H04B 1/38

(52) U.S. Cl. 455/552.1; 375/220

(57) ABSTRACT

There is a need for reducing a chip footprint of a multimode-compatible semiconductor integrated circuit. A reception-based analog front-end unit converts a first RF reception signal according to a first communication system and a second RF reception signal according to a second communication system into a first reception-based analog base band signal having a large signal band and a second reception-based analog base band signal having a small signal band, respectively. An oversampling analog-to-digital converter generates first and second reception-based digital base band signals. A first digital filter is used for a decimation process on the first and second reception-based digital base band signals in common with each other. Second digital filters perform a down-sampling process to generate the first reception-based digital base band signal having the large first sampling rate. Third digital filters perform a down-sampling process to generate the second reception-based digital base band signal having the small second sampling rate.

### CLAIM OF PRIORITY

The present application claims priority from Japanese application JP 2008-220651 filed on Aug. 29, 2008, the content of which is hereby incorporated by reference into this application.

### FIELD OF THE INVENTION

The present invention relates to a semiconductor integrated circuit and a circuit operation method thereof. More particularly, the invention relates to a technology useful for reducing a chip footprint in a semiconductor integrated circuit having a multimode-compatible reception-based digital front-end.

### BACKGROUND OF THE INVENTION

Various cellular and wireless LAN communication systems have evolved, including GSM, GPRS, EDGE, WCDMA, DCS, and PCS, for example. Recently, there is an increasing demand for a multimode/multiband transceiver as a single terminal that is compatible with multiple communication systems or transmission and reception frequency bands. The name GSM stands for Global System for Mobile Communication. The name EDGE stands for Enhanced Data for GSM Evolution or Enhanced Data for GPRS Evolution. The name GPRS stands for General Packet Radio Service. The name WCDMA stands for Wideband Code Division Multiple Access. The name DCS stands for Digital Cellular System. The name PCS stands for Personal Communication System.

Ubiquitous coverage is expected to be provided for communication terminal devices such as mobile stations so as to be capable of wireless communication anywhere in the world. The ubiquitous coverage is unrealistic and is currently under development. The mobile systems include: cellular systems such as GSM, GPRS, EDGE, and WCDMA; and personal area networks compliant with IEEE 802.11-b/a/g such as Bluetooth and Zigbee, for example. Characteristics of the systems indicate a wide range of combinations including signals for a given envelope and an envelope change, multiplex of time division and code division, and transmission output power ranging from high power (several watts) to low power (microwatts). As a result, there is an increasing demand for RF communication in multimode.

A high-frequency IC for mobile stations is increasingly integrated with a base band LSI for digital signal processing into a single chip. Non-Patent Document 1 describes integration of high-frequency ICs (Integrated Circuits) for GSM services with base band LSIs (Large Scale Integration integrated circuits) into a single chip.

Non-Patent Document 2 describes an integrated circuit for third-generation tri-band cellular transceivers compatible with 2100, 1900, and 850/800 MHz. The circuit is intended for worldwide use and is developed as parts of a mobile station that supports the GSM/EDGE quad-band and the WCDMA tri-band. The RF transceiver is integrated with a base band signal processing IC for tri-band WCDMA.

Non-Patent Document 3 describes specifications of a digital interface between an RFIC and a base band. The specifications define the following eight signals for the digital interface. The first signal is equivalent to transmission and reception data (RxTxData) This is a bidirectional signal that transfers a burst signal from the base band to the RFIC during transmission and transfers a multiplexed IQ sample from the RFIC to the base band during reception. The second signal is equivalent to transmission and reception enable (RxTxEn). The base band enables the signal during transmission mode Tx. The RFIC enables the signal during reception mode. The third signal is equivalent to bidirectional control data (CtrlData) for a bidirectional 3-wire control interface that accesses a register set of the RFIC. The fourth signal is equivalent to control enable (CtrlEn) from the base band. The fifth signal is equivalent to control clock (CrlClk) from the base band. The sixth signal is equivalent to a strobe (Strobe) from the base band and is used to provide accurate timing for events inside the RFIC. The seventh signal is equivalent to a system clock (SysClk). The eighth signal is equivalent to system clock enable (SysClkEn). The system clock functions as a 26 MHz master clock output from the RFIC when the base band asserts the SysClkEn signal.

Non-Patent Document 4 describes a GSM-EDGE/CDMA2000/UMTS direct conversion receiver that is completely integrated into a single chip. The receiver includes a fractional PLL, a mixer, a low noise amplifier, an integrated voltage controlled amplifier, an analog antialiasing filter, and a 3-wire bus interface. Key topics are dedicated to a completely configurable digital front-end (DFE), a ΔΣ analog-to-digital converter, and a high-speed digital serial base band (BB) interface. The digital front-end (DFE) includes functions of sample rate conversion, channel filtering, dynamic range control, and signal adjustment for data transfer via a digital interface between the RFIC and the base band IC.

Based on the direct conversion architecture, a reception analog front-end (RxAFE) uses an integrated fractional PLL. The digital front-end (DFE) may be incapable of channel selection filtering In such case, an analog base band filter is used for input to the analog-to-digital converter and eliminates antialiasing components.

The digital front-end (DFE) uses the ΔΣ analog-to-digital converter designed so as to provide a sufficient dynamic range to sample a given signal that may cause an unwanted channel interference. Since a loop filter is tuned to adapt to a signal band, the analog-to-digital converter is supplied with a specified system clock in all modes. A resultant change in an oversampling rate (OSR) necessitates appropriate decimation in the digital front-end (DFE).

A digital signal processing (DSP) block of a reception-based digital front-end (RxDFE) enables the multimode. Functions of the digital front-end (DFE) include channel selection filtering, gain control, and matched filter that are highly dependent on requirements of the standards. Accordingly, the digital front-end (DFE) is fully configurable based on configuration options including all of a decimation factor, filter coefficient, gain, and correction parameter via the 3-wire bus control interface.

The digital signal processing (DSP) block of the reception-based digital front-end (RxDFE) is designed to be most flexible and reconfigurable. A 12-bit word length and a 16-bit data path are provided for all coefficients at all stages so as to be advantageous to a sufficient bypass function at each processing stage.

A signal processing stage of the reception-based digital front-end (RxDFE) includes two CIC filters, a notch filter, an IIR-type waveform digital filter (WD), a third-order all-pass filter, an FIR filter, and a fractional sample rate conversion (FSRC) filter.

The two Cascaded-Integrator-Comb (CIC) filters configure a major decimation stage. The notch filter is used to minimize a DC offset. The seventh-order IIR (Infinite-Impulse Response) type waveform digital filter (WD) configures a channel selection filter. The third-order all-pass filter (AP) compensates for a group delay in the waveform digital filter (WD). Firstly, the FIR (Finite-Impulse Response) filter provides matched filtering in accordance with standard specifications. Secondly, the FIR filter compensates for an oscillation decrease in the analog base band filter, the CIC filter, the WDF filter, and the FSRC filter.

As is well known, random codes 0 and 1 are transmitted through a narrow-bandwidth channel to cause an inter-symbol interference (ISI). To reduce the ISI, the transmitter is provided with pulse shaping (Nyquist signaling) and the receiver is provided with equalization. When a pulse is given the maximum value, the Nyquist signaling zeroes the other pulses. The Nyquist signaling frequently uses a pulse shape that is associated with the raised cosine (RC) spectrum. The amplitude of the raised cosine function reaches the maximum value at a given time on the time axis, reaches zero before and after the maximum value, and reverses the polarity and gradually attenuates before and after the maximum value. The amplitude of the raised cosine function is flat within a given frequency band and gradually attenuates outside the frequency band on the frequency axis. Such process is referred to as raised cosine filtering. Actually, the raised cosine filter is separately inserted into two locations. One is the transmitter. The other is the receiver. A combination of both enables Nyquist signaling because the filter used allows a transfer function to be equivalent to a square root of the above-mentioned function. The receiver filter works as a matched filter.

Non-Patent Document 5 describes that a root raised cosine (RRC) filter for reducing an inter-symbol interference (ISI) configures a pulse shaping filter for FDD-compliant WCDMA based on 3GPP specifications. In a WCDMA wireless system, a downlink uses two RRC filters: one for a base station transmitter and the other for a mobile station receiver. An uplink uses two RRC filters: one for a mobile station transmitter and the other for a base station receiver. The RRC filter uses a finite impulse response (FIR) filter. The name 3GPP stands for 3rd Generation Partnership Project.

Non-Patent Document 6 describes that a dual-mode mobile station is used to support GSM and WCDMA systems and provide seamless handover from WCDMA to GSM and from GSM to WCDMA.

Non-Patent Document 1: Pierre-Henri et al. “A Fully Integrated SoC for GSM/GPRS in 0.13 μm CMOS”, ISSCC 2006, Session 26.7.

Non-Patent Document 2: D. L. Kaczman et al. “A Single-Chip Tri-Band (2100, 1900, 850/800 MHz) WCDMA/HSDPA Cellular Transceiver”, IEEE JOURNAL OF SOLID-STATE CIRCUITS, VOL. 41, No. 5, May 2006, pp. 1122-1132.

Non-Patent Document 3: Andrew Fogg, “DigRF BASEBAND/RF DIGITAL INTERFACE SPECIFICATION”, Logical, Electrical and Timing Characteristics EGPRS Version Digital Interface Working Group Rapporteur Andrew Fogg, TTPCom Version 1.12

http://mipi.org/docs/DigRF_Standard_v112.pdf

Browsed on Jul. 28, 2008.

Non-Patent Document 4: Gernot Hueber et al. “A GSM-EDGE/CDMA2000/UMTS Receiver IC for Cellular Terminals in 0.13 μm CMOS”, Proceedings of the 9th European Conference on Wireless Technology, September 2006, pp. 23-26.

Non-Patent Document 5: Inaki BERENGUER et al. “Efficient VLSI Design of a Pulse Shaping Filter and DAC interface for W-CDMA transmission”, Proceedings. 2003 IEEE International [system-on-Chip] SOC Conference, Sep. 17-20, 2003, pp. 373-376.

Non-Patent Document 6: Gertie Alsenmyr et al. “Handover between WCDMA and GSM”, Ericcson Review No. 1, 2003, pp. 6-11.

### SUMMARY OF THE INVENTION

Prior to the present invention, the inventors researched and developed a radio frequency semiconductor integrated circuit (hereafter referred to as RFIC) that supports a transmission and reception capability in dual mode using WCDMA and GSM/EDGE.

The RFIC needed a multimode-compatible reception-based digital front-end compliant with the multimode for WCDMA and EDGE as described in Non-Patent Document 4. The reception-based digital front-end needs to be supplied with all configuration option data such as decimation factors, filter coefficients, gains, and correction parameters from the outside of the RFIC via the 3-wire bus control interface so as to ensure the configurable reception-based digital front-end described in Non-Patent Document 4. The RFIC including the reception-based digital front-end as configured above may be mounted with a dual mode mobile station that supports GSM/EDGE and WCDMA systems. In such case, the inventors found that an operation is needed to supply the RFIC with the configuration data from the outside before use.

This operation is inconvenient for a user who uses the dual mode mobile station. On the other hand, the operation causes a time-consuming preparation for seamless handover from WCDMA to GSM and from GSM to WCDMA using the dual mode mobile station described in Non-Patent Document 6.

To solve this problem, the invention was preceded by our examination about a possibility of using a first reception-based digital front-end supporting WCDMA and a second reception-based digital front-end supporting GSM/EDGE for output of a reception-based analog end according to a direct down-conversion architecture. A reception operation is available in a low-power consumption multimode by activating one of the two reception-based digital front-ends and inactivating the other. However, our examination made clear that this system requires two reception-based digital front-ends and increases the chip footprint.

The present invention has been made as a result of the inventors examinations prior to the invention.

It is therefore an object of the present invention to reduce a chip footprint of a semiconductor integrated circuit having a multimode-compatible reception-based digital front-end.

These and other objects and novel features of the invention may be readily ascertained by referring to the following description and appended drawings.

The following summarizes representative aspects of the present invention disclosed in the specification.

A semiconductor integrated circuit (1) representative of the invention includes a reception-based analog front-end unit (10), a reception-based digital front-end unit (101), and a digital interface unit (105) (see FIG. 1).

The reception-based analog front-end unit (10) down-converts first and second RF reception signals of first and second communication systems WCDMA and GSM/EDGE into first and second reception-based analog base band signals corresponding to a first large signal band (3.84 MHz) and a second small signal band (270 kHz), respectively. An oversampling analog-to-digital converter (102) converts first and second reception-based analog base band signals into first and second reception-based digital base band signals, respectively.

A first digital filter (103) is used in common with a decimation process of the first and second reception-based digital base band signals. A second digital filter (205, 206, 207) generates the first reception-based digital base band signal having a first large sampling rate (7.68 MHz) resulting from down-sampling an output from the first digital filter (103). A third digital filter (210, 211, 212) generates the second reception-based digital base band signal having a second small sampling rate (0.54 MHz) resulting from down-sampling an output from the first digital filter (103).

The following summarizes an effect resulting from the representative aspects of the present invention disclosed in the specification. It is possible to reduce the chip footprint of the semiconductor integrated circuit having the multimode-compatible reception-based digital front-end.

### BRIEF DESCRIPTION OF THE DRAWINGS

FIG. 1 shows the configuration of an RFIC mounted on a mobile station that performs transmission and reception operations in multimode of WCDMA and GSM/EDGE according to an embodiment of the invention;

FIG. 2 shows in detail a reception-based digital front-end unit of the RFIC mounted on a mobile station that performs transmission and reception operations in multimode of WCDMA and GSM/EDGE shown in FIG. 1 according to the embodiment of the invention;

FIG. 3 shows in detail a transmission-based digital front-end unit of the RFIC mounted on a mobile station that performs transmission and reception operations in multimode of WCDMA and GSM/EDGE shown in FIG. 1 according to the embodiment of the invention;

FIG. 4 shows relation between a sampling frequency and an S/N ratio of an oversampling ΔΣ analog-to-digital converter included in the reception-based digital front-end unit of the RFIC mounted on a mobile station that performs transmission and reception operations in multimode of WCDMA and GSM/EDGE shown in FIG. 1 according to the embodiment of the invention;

FIGS. 5A and 5B show relation between an interpolation ratio and the other operation setting parameters in an interpolation section of the reception-based digital front-end unit of the RFIC that performs transmission and reception operations in multimode of WCDMA and GSM/EDGE in FIG. 2 according to the embodiment of the invention;

FIG. 6 shows relation between a dividing ratio of a second divider and a frequency of a second frequency dividing clock signal as output from the second divider coupled to the oversampling ΔΣ analog-to-digital converter of the reception-based digital front-end unit of the RFIC that performs transmission and reception operations in multimode of WCDMA and GSM/EDGE in FIG. 2 according to the embodiment of the invention;

FIG. 7 illustrates time adjustment requisite for a WCDMA communication system;

FIG. 8 shows the configuration of the transmission-based digital front-end unit capable of time adjustment for WCDMA communication in the RFIC as shown in FIGS. 1 and 3 according to the embodiment of the invention;

FIG. 9 illustrates coupling between a base band LSI and an RFIC, the base band LSI being used for time adjustment of addition and deletion based on a ¼-chip step width and the RFIC being used for time adjustment of addition and deletion based on a ⅕-chip step width;

FIG. 10 shows the configuration of an FIR digital filter functioning as a root raised cosine filter shown in FIGS. 3 and 8;

FIG. 11 shows how the configuration of the FIR digital filter in FIG. 10 functioning as a root raised cosine filter varies with flag information about chip addition or deletion for time adjustment; and

FIG. 12 shows the configuration of a PLL frequency synthesizer and a voltage-controlled oscillator used for the RFIC mounted on a mobile station that performs transmission and reception operations in multimode of WCDMA and GSM/EDGE as shown in FIGS. 1, 2, and 3 according to the embodiment of the invention.

### DETAILED DESCRIPTION OF THE PREFERRED EMBODIMENTS

### Representative Embodiment

The following summarizes a representative embodiment of the invention disclosed in this specification. The description uses a parenthesized reference numeral in the accompanying drawings. The reference numeral just indicates an example of the concept of an element to which the reference numeral is assigned.

<1> A semiconductor integrated circuit (1) according to the representative embodiment of the invention includes a reception-based analog front-end unit (10), a reception-based digital front-end unit (101), and a digital interface unit (105).

The reception-based analog front-end unit (10) works as a receiver that down-coverts an RF reception signal received by an antenna (ANT) mounted on a communication terminal into a reception-based analog base band signal.

The reception-based digital front-end unit (101) includes an analog-to-digital converter (102) and a reception-based digital filter unit (103, 205, 206, 207, 210, 211, 212).

The analog-to-digital converter (102) converts the reception-based analog base band signal supplied from output of the reception-based analog front-end unit (10) into a reception-based digital base band signal.

The reception-based digital base band signal from the analog-to-digital converter (102) is transmitted to the digital interface unit (105) via the reception-based digital filter unit.

The digital interface unit (105) can supply an external digital base band processing unit (901) with the reception-based digital base band signal transmitted from the reception-based digital filter unit.

The antenna receives a first RF reception signal according to the first communication system (WCDMA) and a second RF reception signal according to the second communication system (GSM/EDGE). The reception-based analog front-end unit (10) can down-convert the first and second RF reception signals into first and second reception-based analog base band signals, respectively. The first reception-based analog base band signal has a first signal band (3.84 MHz). The second reception-based analog base band signal has a second signal band (270 kHz) narrower than the first signal band.

The analog-to-digital converter (102) of the reception-based digital front-end unit (101) is configured as an oversampling analog-to-digital converter.

The reception-based analog front-end unit (10) supplies the first and second reception-based analog base band signals. The analog-to-digital converter (102) can convert the first and second reception-based analog base band signals into first and second reception-based digital base band signals, respectively.

The reception-based digital filter unit of the reception-based digital front-end unit (101) Includes a first digital filter (103) coupled with output from the oversampling analog-to-digital converter (102).

The oversampling analog-to-digital converter supplies the first and second reception-based digital base band signals. The first digital filter (103) can be used in common with a decimation process of the first reception-based digital base band signal and that of the second reception-based digital base band signal.

The reception-based digital filter unit further includes a second digital filter (205, 206, 207) and a third digital filter (210, 211, 212) parallel coupled between an output from the first digital filter (103) and the digital interface unit (105).

The second digital filter (205, 206, 207) down-samples the first reception-based digital base band signal from the output of the first digital filter (103) based on the first communication system (WCDMA). In this manner, the second digital filter supplies the digital interface unit (105) with the first reception-based digital base band signal having the first sampling rate (7.68 MHz).

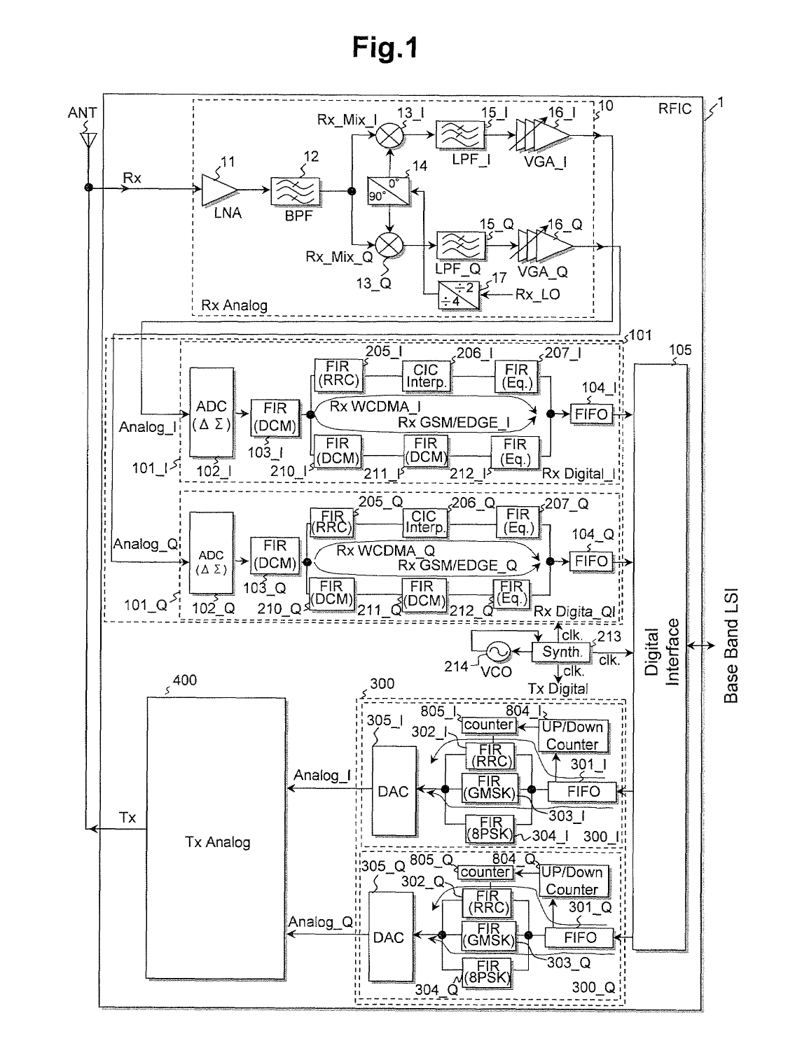

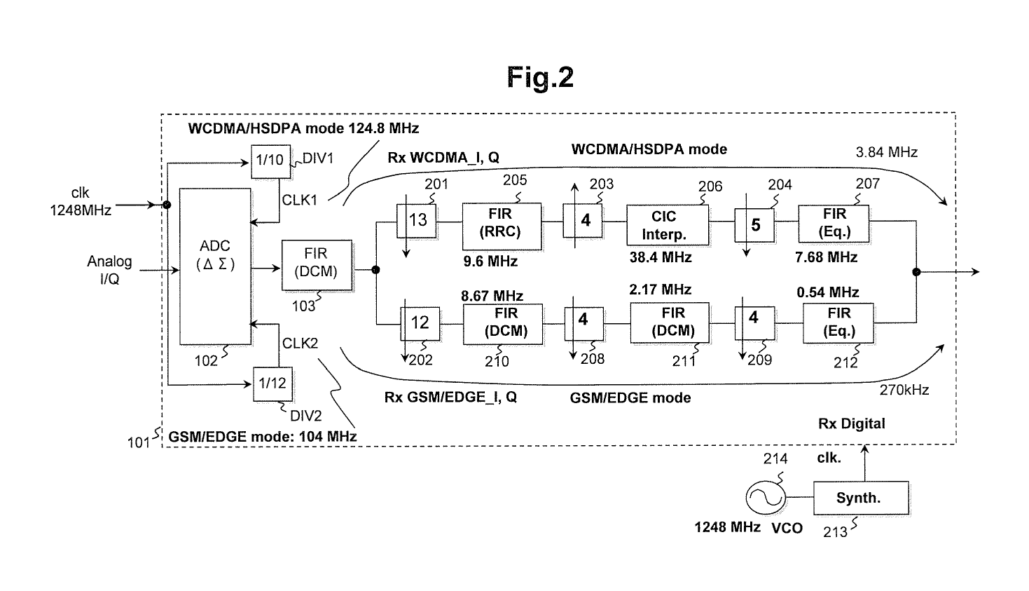

The third digital filter (210, 211, 212) down-samples the second reception-based digital base band signal from the output of the first digital filter (103) based on the second communication system GSM/EDGE). In this manner, the third digital filter supplies the digital interface unit (105) with the second reception-based digital base band signal having the second sampling rate (0.54 MHz) smaller than the first sampling rate (see FIGS. 1 and 2).

According to the embodiment, the oversampling analog-to-digital converter (102) and the first digital filter (103) are used in common with the two systems, that is, the first communication system (WCDMA) and the second communication system (GSM/EDGE) for reception-based digital base band signal processing. It is possible to reduce the chip footprint of the reception-based digital front-end unit (101) so as to be compliant with the multimode. A difference in the sampling rates for the two reception-based digital base band signals can be easily adjusted through the use of a difference in the sampling rate conversion ratios for the second and third digital filters that are parallel coupled at the output.

The second digital filter generates the first reception-based digital base band signal having the first sampling rate. The third digital filter generates the second reception-based digital base band signal having the second sampling rate. According to a preferred embodiment, the second and third digital filters are each provided with a difference in the down-sampling rate conversion ratios corresponding to a difference between the first and second signal bands for the first and second reception-based analog base band signals.

According to another preferred embodiment, the second digital filter (205, 206, 207) includes an interpolation section (203) provided with an interpolation ratio assigned a specified value. The difference in the down-sampling rate conversion ratios is generated from the specified value of the interpolation ratio (see FIG. 2).

According to still another preferred embodiment, the reception-based digital front-end unit (101) further includes a reception memory buffer (104) (see FIGS. 1 and 2). The reception memory buffer (104) temporarily stores the reception-based digital base band signal processed by the reception-based digital filter unit and then supplies the stored signal to the digital interface unit (105).

According to yet another preferred embodiment, the second digital filter (205, 206, 207) further includes a first root raised cosine filter (205) that reduces an inter-decoding interference (see FIGS. 1 and 2).

According to still yet another preferred embodiment, the reception-based analog front-end unit (10) and the reception-based digital front-end unit (101) process the first and second RF reception signals (see FIGS. 1 and 2). The first RF reception signal is used for the WCDMA communication system as the first communication system. The second RF reception signal is used for the GSM/EDGE communication system as the second communication system.

The semiconductor integrated circuit (1) according to a specific embodiment further includes a transmission-based digital front-end unit (300) and a transmission-based analog front-end unit (400) (see FIG. 1).

The digital interface unit (105) can supply the transmission-based digital front-end unit (300) with a transmission-based digital base band signal transmitted from the external digital base band processing unit (901).

The transmission-based digital front-end unit (300) includes a transmission-based digital filter unit (302, 303, 304) and a D/A converter (305).

The transmission-based digital filter unit transmits the transmission-based digital base band signal supplied from the digital interface unit (105) to the D/A converter (305).

The D/A converter (305) converts the transmission-based digital base band signal supplied from output of the transmission-based digital filter unit (302, 303, 304) into a transmission-based analog base band signal.

The transmission-based analog front-end unit (400) works as a transmitter that up-converts the transmission-based analog base band signal from output of the D/A converter (305) into an RF transmission signal.

According to another specific embodiment, the transmission-based digital filter unit (302, 303, 304) includes a fourth digital filter (302, 306) and a fifth digital filter (303, 304, 307, 308) parallel coupled between the digital interface unit (105) and the D/A converter (305).

The fourth digital filter (302, 306) supplies the first transmission-based digital base band signal to the input of the D/A converter (305). The first transmission-based digital base band signal is provided with a third sampling rate (19.2 MHz) after the first transmission-based digital base band signal is supplied from the digital interface unit (105) and is up-sampled based on the first communication system (WCDMA).

The fifth digital filter (303, 304, 307, 308) supplies the second transmission-based digital base band signal to the input of the D/A converter (305). The second transmission-based digital base band signal is provided with a fourth sampling rate (6.5 MHz) after the second transmission-based digital base band signal is supplied from the digital interface unit (105) and is up-sampled based on the second communication system (GSM/EDGE).

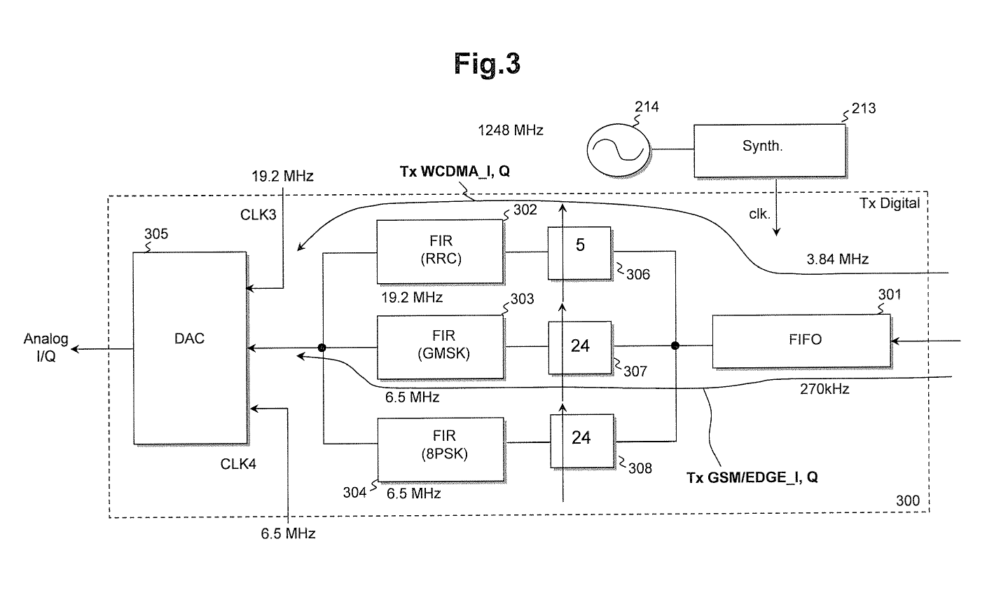

According to still another specific embodiment, the transmission-based digital front-end unit (300) further includes transmission buffer memory (301) (see FIGS. 1 and 3). The transmission buffer memory (301) temporarily stores the transmission-based digital base band signal transmitted from the external digital base band processing unit (901) and supplies the stored signal to the transmission-based digital filter unit (302, 303, 304).

According to yet another specific embodiment, the fourth digital filter (302, 306) includes a second root raised cosine filter (302) for reducing an inter-decoding interference (see FIG. 3).

<2> The representative embodiment of the invention according to another aspect relates to an operation method of the semiconductor integrated circuit (1) having the reception-based analog front-end unit (10), the reception-based digital front-end unit (101), and the digital interface unit (105).

The reception-based analog front-end unit (10) works as a receiver that down-coverts an RF reception signal received by an antenna (ANT) mounted on a communication terminal into a reception-based analog base band signal.

The reception-based digital front-end unit (101) includes an analog-to-digital converter (102) and a reception-based digital filter unit (103, 205, 206, 207, 210, 211, 212).

The analog-to-digital converter (102) converts the reception-based analog base band signal supplied from output of the reception-based analog front-end unit (10) into a reception-based digital base band signal.

The reception-based digital base band signal from the analog-to-digital converter (102) is transmitted to the digital interface unit (105) via the reception-based digital filter unit.

The digital interface unit (105) can supply an external digital base band processing unit (901) with the reception-based digital base band signal transmitted from the reception-based digital filter unit.

The antenna receives a first RF reception signal according to the first communication system (WCDMA) and a second RF reception signal according to the second communication system (GSM/EDGE). The reception-based analog front-end unit (10) can down-convert the first and second RF reception signals into first and second reception-based analog base band signals, respectively. The first reception-based analog base band signal has a first signal band (3.84 MHz). The second reception-based analog base band signal has a second signal band (270 kHz) narrower than the first signal band.

The analog-to-digital converter (102) of the reception-based digital front-end unit (101) is configured as an oversampling analog-to-digital converter.

The reception-based analog front-end unit (10) supplies the first and second reception-based analog base band signals. The analog-to-digital converter (102) can convert the first and second reception-based analog base band signals into first and second reception-based digital base band signals, respectively.

The reception-based digital filter unit of the reception-based digital front-end unit (101) Includes a first digital filter (103) coupled with output from the oversampling analog-to-digital converter (102).

The oversampling analog-to-digital converter supplies the first and second reception-based digital base band signals. The first digital filter (103) can be used in common with a decimation process of the first reception-based digital base band signal and that of the second reception-based digital base band signal.

The reception-based digital filter unit further includes a second digital filter (205, 206, 207) and a third digital filter (210, 211, 212) parallel coupled between an output from the first digital filter (103) and the digital interface unit (105).

The second digital filter (205, 206, 207) down-samples the first reception-based digital base band signal from the output of the first digital filter (103) based on the first communication system (WCDMA). In this manner, the second digital filter supplies the digital interface unit (105) with the first reception-based digital base band signal having the first sampling rate (7.68 MHz).

The third digital filter (210, 211, 212) down-samples the second reception-based digital base band signal from the output of the first digital filter (103) based on the second communication system GSM/EDGE). In this manner, the third digital filter supplies the digital interface unit (105) with the second reception-based digital base band signal having the second sampling rate (0.54 MHz) smaller than the first sampling rate (see FIGS. 1 and 2).

<Description of the Embodiments>

The following describes the embodiments in more detail. In all the drawings for illustrating the preferred embodiments of the invention, parts having the same function are denoted by the same reference numeral and a detailed description is omitted for simplicity.

<RFIC Configuration>

FIG. 1 shows the configuration of an RF semiconductor integrated circuit (hereafter referred to as RFIC) mounted on a mobile station capable of transmission and reception operations in multimode of WCDMA and GSM/EDGE according to the embodiment of the invention.

An RFIC 1 in FIG. 1 includes a reception-based analog front-end unit 10, a reception-based digital front-end unit 101, a digital interface unit 105, a transmission-based digital front-end unit 300, and a transmission-based analog front-end unit 400.

The reception-based analog front-end unit 10 complies with the architecture of direct down-conversion receivers and converts an RF reception signal received at an antenna ANT into a reception-based analog base band signal.

The reception-based digital front-end unit 101 includes an analog-to-digital converter and a digital filter so as to supply the digital interface unit 105 with a reception-based digital base band signal.

The digital interface unit 105 transfers a reception-based digital base band signal supplied from the reception-based digital front-end unit 101 to a base band LSI (not shown). On the other hand, the digital interface unit 105 supplies the transmission-based digital front-end unit 300 with a transmission-based digital base band signal transferred from the base band LSI (not shown).

The transmission-based digital front-end unit 300 includes a digital filter and a D/A converter so as to supply the transmission-based analog front-end unit 400 with a transmission-based analog base band signal.

The transmission-based analog front-end unit 400 complies with the architecture of a frequency up-conversion transmitter and converts a transmission-based analog base band signal into an RF transmission signal in terms of frequencies.

<Reception-Based Analog Front-End>

The reception-based analog front-end unit 10 complies with the architecture of direct down-conversion receivers. The reception-based analog front-end unit 10 transforms an RF reception signal received at the antenna ANT into I-phase (In-phase) and Q-phase (Quadrature-phase) reception-based analog base band signals.

A low noise amplifier 11 amplifies an RF reception signal received at the antenna ANT. The amplified signal passes through a bandpass filter 12 and is supplied to one input terminal of a first reception mixer 13_I and one input terminal of a second reception mixer 13_Q. A high-frequency signal from a divider 17 is supplied to a phase shifter 14. The phase shifter 14 supplies a received local signal of a zero-degree phase to the other input terminal of the first reception mixer 13_I. The phase shifter 14 supplies a received local signal of a 90-degree phase to the other input terminal of the second reception mixer 13_Q. Output terminals of the first reception mixer 13_I and the second reception mixer 13_Q generate I-phase and Q-phase reception-based analog base band signals, respectively. The I-phase and Q-phase reception-based analog base band signals pass through first and second low-pass filters 15_I and 15_Q and are supplied to input terminals of first and second variable gain amplifier 16_I and 16_Q.

The I-phase reception-based analog base band signal at the output terminal of the first variable gain amplifier 16_I is supplied to a first digital signal processing unit 101_I of the reception-based digital front-end unit 101. The Q-phase reception-based analog base band signal at the output terminal of the second variable gain amplifier 16_Q is supplied to a second digital signal processing unit 101_Q of the reception-based digital front-end unit 101.

<Reception-Based Digital Front-End Unit>

The first digital signal processing unit 101_I and the second digital signal processing unit 101_Q of the reception-based digital front-end unit 101 perform a digital signal process on I-phase and Q-phase reception-based analog base band signals and therefore comply with the same architecture.

<Oversampling ΔΣ Analog-to-Digital Converter and FIR Decimation Filter as Inputs>

The first and second digital signal processing units 101_I and 101_Q include the oversampling ΔΣ analog-to-digital converters 102_I and 102_Q, and the first FIR digital filters 103_I and 103_Q as inputs that are used in common with received signal processes based on WCDMA and GSM/EDGE. The analog-to-digital converters 102_I and 102_Q as common inputs use oversampling ΔΣ analog-to-digital converters that reduce a folding noise or a quantization noise. The oversampling analog-to-digital converter uses a sampling frequency much higher than the Nyquist frequency to interpolate discrete sampling values, allowing high-accuracy A/D conversion. The oversampling ΔΣ analog-to-digital converter uses a feedback loop to shape a quantization noise spectrum. Compared to a conventional Nyquist-ratio analog-to-digital converter, the oversampling ΔΣ analog-to-digital converter is insensitive to non-ideal characteristics of an analog circuit.

The oversampling ΔΣ analog-to-digital converters 102_I and 102_Q use too high a sampling rate compared to signal bands for reception-based analog base band signals based on WCDMA or GSM/EDGE and therefore require a decimation process, that is, down-sampling to a sampling rate appropriate to the signal band for reception-based analog base band signals. As is well known, an FIR (Finite Impulse Response) filter is used to remove a signal component as an alias (folding component) resulting from the decimation process. Accordingly, the first FIR digital filters 103_I and 103_Q coupled to the oversampling ΔΣ analog-to-digital converters 102_I and 102_Q function as decimation filters that remove a signal component as an alias resulting from the decimation process.

<Intermediate WCDMA Signal Process>

In an intermediate portion, the first and second digital signal processing units 101_I and 101_Q include second FIR digital filters 205_I and 205_Q, CIC digital filters 206_I and 206_Q, and third FIR digital filters 207_I and 207_Q for down-sampling WCDMA-received signals. Down-sampling WCDMA-received signals in the intermediate portion further decreases a sampling rate for WCDMA reception-based digital base band signals.

As mentioned above, the second FIR digital filters 205_I and 205_Q at the initial stage of the WCDMA process in the intermediate portion function as root raised cosine (RRC) filters that reduce an inter-symbol interference (ISI) in the WCDMA wireless system based on 3GPP specifications.

The CIC digital filters digital filter 206_I and 206_Q in the intermediate portion at the intermediate stage of the WCDMA process function as an interpolation filter and a decimation filter. The CIC (Cascaded-Integrator-Comb) filter has characteristics of a multi-rate filter appropriate for providing a large sampling rate. The CIC filter can provide both decimation and interpolation functions. The CIC filter does not need a digital multiplier and can include an adder, a subtracter, and a register for configuration.

The second FIR digital filters 207_I and 207_Q in the intermediate portion at the final stage of the WCDMA process function as digital equalizer filters that compensate for degradation of a received signal due to a ripple in the signal band or a group delay difference in the bandpass filter 12 or the low-pass filters 15_I and 15_Q of the reception-based analog front-end unit 10.

<GSM/EDGE Signal Processing in the Intermediate Portion>

The first and second digital signal processing units 101_I and 101_Q further include fourth FIR digital filters 210_I and 210_Q, fifth FIR digital filters 211_I and 211_Q, and sixth FIR digital filters 212_I and 212_Q in the intermediate portion for down-sampling GSM/EDGE received signals.

A base band signal uses a wide band of approximately 3.84 MHz during WCDMA reception based on HSDPA (High Speed Downlink Packet Access) as a high speed data transfer A base band signal uses a narrow band of approximately 270 kHz, approximately one tenth of that wide band, during GSM/EDGE reception.

The first FIR digital filters 103_I and 103_Q function as decimation filters in the common input portion and decimate reception-based digital base band signals as outputs from the oversampling ΔΣ analog-to-digital converters 102_I and 102_Q. The decimation using the first FIR digital filters 103_I and 103_Q in the common input portion is sufficient for base band signals received by WCDMA for wide signal bands but is insufficient for base band signals received by GSM/EDGE for narrow signal bands. The decimation for base band signals received by GSM/EDGE for narrow signal bands needs not only the decimation process using the first FIR digital filters 103_I and 103_Q in the common input portion but also an additional decimation process and an accompanying decimation filter for removing alias signal components.

The first and second digital signal processing units 101_I and 101_Q include the fourth FIR digital filters 210_I and 210_Q and the fifth FIR digital filters 211_I and 211_Q in the intermediate portion for processing signals received by the GSM/EDGE. The filters are used for the additional decimation process on base band signals received by the GSM/EDGE for narrow signal bands and function as FIR decimation filters for removing alias signal components. The down-sampling process on signals received by the GSM/EDGE in the intermediate portion decreases a sampling rate for digital base band signals received by the GSM/EDGE more remarkably than the WCDMA down-sampling process for decreasing the sampling rate in the intermediate portion.

The sixth FIR digital filters 212_I and 212_Q in the intermediate portion at the final stage of the GSM/EDGE process function as digital equalizer filters that compensate for degradation of a received signal due to a ripple in the signal band or a group delay difference in the bandpass filter 12 or the low-pass filters 15_I and 15_Q of the reception-based analog front-end unit 10.

<Reception FIFO Memory>

A received base band signal is processed by the WCDMA or the GSM/EDGE in the intermediate portion of the first and second digital signal processing units 101_I and 101_Q. The processed base band signal is temporarily stored in the reception FIFO (First In/First Out) memories 104_I and 104_Q and then is supplied to the digital interface unit 105.

<Digital Interface Unit>

The digital interface unit 105 transfers a reception-based digital base band signal supplied from the reception-based digital front-end unit 101 to a base band LSI (not shown). On the other hand, the digital interface unit 105 supplies the transmission-based digital front-end unit 300 with a transmission-based digital base band signal transferred from the base band LSI (not shown).

The digital interface unit 105 is configured in accordance with the digital interface specifications described in Non-Patent Document 3. In addition, the digital interface unit 105 may be compliant with the DigRF v3 standard standardized by the DigRF Working Croup in the organization called MIPI (Mobile Industry Processor Interface Alliance).

The digital interface unit 105 is coupled to a PLL frequency synthesizer 213 and a voltage-controlled oscillator (VCO) 214 under control of a system clock (SysClk) in accordance with digital interface specifications. A frequency of 1248 MHz is predetermined for the oscillation frequency of the voltage-controlled oscillator (VCO) 214 and a clock signal clk generated from the PLL frequency synthesizer 213.

<Transmission-Based Digital Front-End Unit>

The third digital signal processing unit 300_I and the fourth digital signal processing unit 300_Q of the transmission-based digital front-end unit 300 perform a digital signal process on I-phase and Q-phase transmission-based digital base band signals and therefore comply with the same architecture.

The transmission-based digital front-end unit 300 includes transmission FIFO (First In/First Out) memories 301_I and 301_Q for temporarily storing a transmission-based digital base band signal transferred from the base band LSI (not shown).

A transmission-based digital baseband signal transmitted from the transmission-based digital front-end unit 300 may be equivalent to a WCDMA transmission-based digital base band signal according to HSUPA (High-Speed Uplink Packet Access) as a high-speed data transfer. The signal is read from the transmission FIFO memories 301_I and 301_Q and then is supplied to FIR digital filters 302_I and 302_Q functioning as root raised cosine (RRC) filters that reduce an inter-symbol interference (ISI) in the WCDMA wireless system. The WCDMA transmission-based digital base band signal is interpolated by the FIR digital filters 302_I and 302_Q and then is supplied to D/A converters 305_I and 305_Q in the common output portion.

When a GSM transmission-based digital base band signal is to be transmitted, the signal is read from the transmission FIFO memories 301_I and 301_Q and then is supplied to filters 303_I and 303_Q that generate GMSK (Gaussian Minimum Shift Keying) modulation waveforms. The GSM transmission-based digital base band signal is subjected to a modulation waveform generation process and an interpolation process in the filters 303_I and 303_Q and then is supplied to the D/A converters 305_I and 305_Q in the common output portion

When an EDGE transmission-based digital base band signal is to be transmitted, the signal is read from the transmission FIFO memories 301_I and 301_Q and then is supplied to filters 304_I and 304_Q that generate 8PSK (Eight Phase Shift Keying) modulation waveforms. The EDGE transmission-based digital base band signal is subjected to a modulation waveform generation process and an interpolation process in the filters 304_I and 304_Q and then is supplied to the D/A converters 305_I and 305_Q in the common output portion

The D/A converters 305_I and 305_Q in the common output portion convert the I-phase and Q-phase transmission-based digital base band signals according to any of the WCDMA, GSM, and EDGE transmissions into I-phase and Q-phase transmission-based analog base band signals.

<Transmission-Based Analog Front-End Unit>

The transmission-based analog front-end unit 400 complies with the architecture of an up-conversion transmitter that frequency-converts the I-phase and Q-phase transmission-based analog base band signals from the D/A converters 305_I and 305_Q into an RF transmission signal transmitted by an RF power amplifier (not shown) and the antenna ANT.

<Detailed Configuration of the Reception-Based Digital Filter Unit>

FIG. 2 shows a detailed configuration of the reception-based digital filter unit 10 in the RFIC mounted on a mobile station that performs transmission and reception operations in multimode of WCDMA and GSM/EDGE according to the embodiment of the invention.

The same configuration is used for the first digital signal processing unit 101_I supplied with I-phase reception-based analog base band signals and the second digital signal processing unit 101_Q supplied with Q-phase reception-based analog base band signals in FIG. 1. The reception-based digital front-end unit 101 in FIG. 2 shows the configuration in detail.

As shown in FIG. 2, the reception-based digital front-end unit 101 is coupled to a first divider DIV1 for WCDMA reception operations and a second divider DIV2 for GSM/EDGE reception operations.

An oversampling ΔΣ analog-to-digital converter 102 is supplied with a reception-based analog base band signal from the reception-based analog front-end unit 10. The oversampling ΔΣ analog-to-digital converter 102 is further supplied with a first frequency dividing clock signal CLK1 from an output of the first divider DIV1 and a second frequency dividing clock signal CLK2 from an output of the second divider DIV2. An input terminal of the first divider DIV1 and that of the second divider DIV2 are supplied with a clock signal clk at the 1248 MHz frequency generated from the PLL frequency synthesizer 213 and the voltage-controlled oscillator (VCO) 214 in FIG. 1.

During the WCDMA reception, the first divider DIV1 performs a dividing operation at dividing count 10. The ΔΣ analog-to-digital converter 102 is supplied with the first frequency dividing clock signal CLK1 at the 124.8 MHz frequency from an output of the first divider DIV1. During the GSM/EDGE reception, the second divider DIV2 performs a dividing operation at dividing count 12. The ΔΣ analog-to-digital converter 102 is supplied with the second frequency dividing clock signal CLK2 at the 104 MHz frequency from an output of the second divider DIV2.

During the WCDMA reception, a reception-based digital base band signal at the sampling rate of 124.8 MHz frequency is supplied from an output terminal of the oversampling ΔΣ analog-to-digital converter 102 to an input terminal of the first FIR digital filter 103 functioning as a decimation filter for removing alias signal components. An output terminal of the first FIR digital filter 103 is coupled to an input terminal of a decimation section 201 whose decimation rate is set to 13. The output terminal of the decimation section 201 generates a reception-based digital base band signal at the sampling rate of 9.6 MHz frequency.

The reception-based digital base band signal is supplied to an input terminal of the second FIR digital filter 205 as the root raised cosine (RRC) filter that reduces an inter-symbol interference (ISI). An input terminal of an interpolation section 203 with its interpolation ratio set to 4 is coupled between an output terminal of the second FIR digital filter 205 and an input terminal of the CIC digital filter 206 as an interpolation filter and a decimation filter. An output terminal of the interpolation section 203 generates a reception-based digital base band signal at the sampling rate of 38.4 MHz frequency. An output terminal of the CIC digital filter 206 is coupled to an input terminal of a decimation section 204 with its decimation rate set to 5. An output terminal of the decimation section generates a reception-based digital base band signal at the sampling rate of 7.68 MHz frequency.

An output terminal of the second FIR digital filter 207 as a digital equalizer filter at the final stage generates a reception-based digital base band signal at the sampling rate of 7.68 MHz frequency that is double the signal band of approximately 3.84 MHz for WCDMA-received base band signals based on HSDPA. The signal is supplied to the base band LSI via a digital interface 105.

During the GSM/EDGE reception, a reception-based digital base band signal at the sampling rate of 104 MHz frequency is supplied from an output terminal of the oversampling ΔΣ analog-to-digital converter 102 to an input terminal of the first FIR digital filter 103 functioning as a decimation filter for removing alias signal components. An output terminal of the first FIR digital filter 103 is coupled to an input terminal of a decimation section 202 whose decimation rate is set to 12. The output terminal of the decimation section 202 generates a reception-based digital base band signal at the sampling rate of 8.67 MHz frequency.

The reception-based digital base band signal during the GSM/EDGE reception passes through the fourth FIR digital filter 210 that is used for an additional decimation process and functions as an FIR decimation filter for removing alias signal components. The signal is supplied to an input terminal of a decimation section 208 whose decimation rate is set to 4. An output terminal of the decimation section 208 generates a reception-based digital base band signal at the sampling rate of approximately 2.17 MHz frequency.

The reception-based digital base band signal during the GSM/EDGE reception passes through the fifth FIR digital filter 211 that is used for an additional decimation process and functions as an FIR decimation filter for removing alias signal components. The signal is supplied to an input terminal of a decimation section 209 whose decimation rate is set to 4. An output terminal of the decimation section 209 generates a reception-based digital base band signal at the sampling rate of approximately 0.54 MHz frequency.

An output terminal of a sixth FIR digital filter 212 as a digital equalizer filter at the final stage generates a reception-based digital base band signal at the sampling rate of 0.54 MHz frequency that is double the signal band of approximately 0.27 MHz for GSM/EDGE-received base band signals. The signal is supplied to the base band LSI via the digital interface 105.

<Detailed Configuration of the Transmission-Based Digital Front-End Unit>

FIG. 3 shows in detail the transmission-based digital front-end unit 300 of the RFIC mounted on a mobile station that performs transmission and reception operations in multimode of WCDMA and GSM/EDGE shown in FIG. 1 according to the embodiment of the invention.

The same configuration is used for the third digital signal processing unit 300_I supplied with I-phase reception-based analog base band signals and the fourth digital signal processing unit 300_Q supplied with Q-phase reception-based analog base band signals in FIG. 1. The transmission-based digital front-end unit 300 in FIG. 3 shows the configuration in detail.

As shown in FIG. 3, the transmission-based digital front-end unit 300 includes transmission FIFO memory 301 for temporarily storing a transmission-based digital base band signal transferred from the base band LSI (not shown).

When an HSUPA-based WCDMA transmission-based digital base band signal of the 3.84 MHz signal band is to be transmitted, the signal is read from the transmission FIFO memory 301 and then is supplied to an input terminal of an interpolation section 306 with its interpolation ratio set to 5. An output terminal of the interpolation section 306 generates a transmission-based digital base band signal at the sampling rate of 19.2 MHz frequency. The signal is supplied to an FIR digital filter 302 functioning as a root raised cosine (RRC) filter that reduces an inter-symbol interference (ISI) in the WCDMA wireless system. The WCDMA transmission-based digital base band signal is filtered by the FIR digital filters 302_I and 302_Q and is supplied to the D/A converter 305 in the common output portion.

The interpolation section 306 supplies the D/A converter 305 with a WCDMA transmission-based digital base band signal at the 19.2 MHz frequency. The D/A converter 305 is also supplied with a third frequency dividing clock signal CLK3 at the 19.2 MHz frequency. The third frequency dividing clock signal CLK3 at the 19.2 MHz frequency and a sampling clock signal at the 19.2 MHz frequency used for the interpolation section 306 can be generated by dividing a 1248 MHz frequency clock signal clk by 65. The clock signal clk is generated from the PLL frequency synthesizer 213 and the voltage-controlled oscillator (VCO) 214.

When a GSM transmission-based digital base band signal of approximately the 270 kHz signal band is to be transmitted, the signal is read from the transmission FIFO memory 301 and then is supplied to an input terminal of an interpolation section 307 with its interpolation ratio set to 24. An output terminal of the interpolation section 307 generates a transmission-based digital baseband signal at the sampling rate of approximately 6.5 MHz frequency. The signal is supplied to a GMSK modulation waveform generation filter 303. The GSM transmission-based digital base band signal is interpolated by the GMSK modulation waveform generation filter 303 and then is supplied to the D/A converter 305 in the common output portion.

The interpolation section 307 supplies the D/A converter 305 with a GSM transmission-based digital base band signal at the 6.5 MHz frequency. The D/A converter 305 is also supplied with a fourth frequency dividing clock signal CLK4 at the 6.5 MHz frequency. The fourth frequency dividing clock signal CLK4 at the 6.5 MHz frequency and a sampling clock signal at the 6.5 MHz frequency used for the interpolation section 307 can be generated by dividing a 1248 MHz frequency clock signal clk by 192. The clock signal clk is generated from the PLL frequency synthesizer 213 and the voltage-controlled oscillator (VCO) 214.

When an EDGE transmission-based digital base band signal of approximately the 270 kHz signal band is to be transmitted, the signal is read from the transmission FIFO memory 301 and then is supplied to an input terminal of an interpolation section 308 with its interpolation ratio set to 24. An output terminal of the interpolation section 308 generates a transmission-based digital baseband signal at the sampling rate of approximately 6.5 MHz frequency. The signal is supplied to an 8PSK modulation waveform generation filter 304. The EDGE transmission-based digital base band signal is interpolated by the 8PSK modulation waveform generation filter 304 and then is supplied to the D/A converter 305 in the common output portion.

The interpolation section 308 supplies the D/A converter 305 with an EDGE transmission-based digital base band signal at the 6.5 MHz frequency. The D/A converter 305 is also supplied with a fourth frequency dividing clock signal CLK4 at the 6.5 MHz frequency. The fourth frequency dividing clock signal CLK4 at the 6.5 MHz frequency and a sampling clock signal at the 6.5 MHz frequency used for the interpolation section 308 can be generated by dividing a 1248 MHz frequency clock signal clk by 192. The clock signal clk is generated from the PLL frequency synthesizer 213 and the voltage-controlled oscillator (VCO) 214.

<Sampling Frequency of the Oversampling ΔΣ Analog-to-Digital Converter>

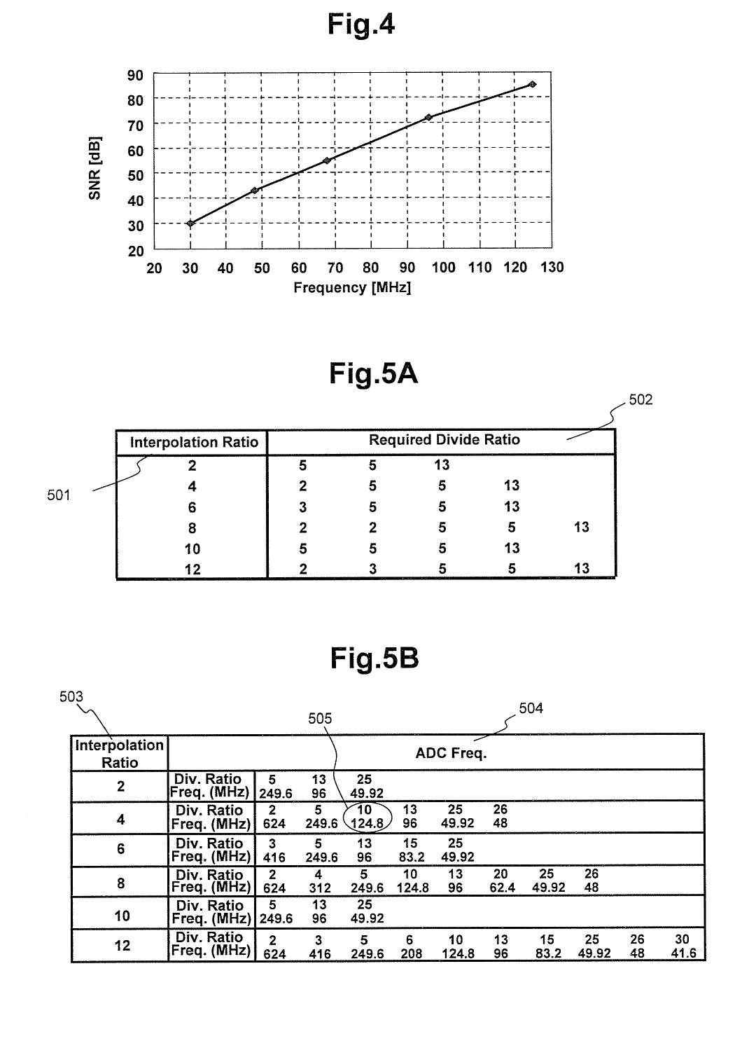

FIG. 4 shows relation between a sampling frequency and an S/N ratio of the oversampling ΔΣ analog-to-digital converter 102 included in the reception-based digital front-end unit 101 of the RFIC mounted on a mobile station that performs transmission and reception operations in multimode of WCDMA and GSM/EDGE shown in FIG. 1 according to the embodiment of the invention.

As shown in FIG. 4, increasing a sampling frequency of the oversampling ΔΣ analog-to-digital converter increases an S/N ratio (SNR). A noise generated from the reception circuit may affect on reception of a WCDMA-received signal based on HSDPA (High Speed Downlink Packet Access) as a high-speed data transfer. It is also necessary to take into account a quantization noise generated from the oversampling ΔΣ analog-to-digital converter.

Particularly, during reception of WCDMA-received signals based on HSDPA, the analog-to-digital converter requires the S/N ratio (SNR) approximately between 50 to 75 dB depending on to what degree the analog filter suppresses an interfering wave. As can be seen from FIG. 4, the oversampling ΔΣ analog-to-digital converter 102 requires the sampling frequency of approximately 60 MHz or higher. An operational margin needs to be ensured in view of RFIC manufacturing variations and an effect of a jitter generated from the oversampling ΔΣ analog-to-digital converter 102 during sampling. The sampling frequency of 100 MHz or higher can ensure a sufficient operational margin and maintain a highs/N ratio (SNR) even when the analog filter less effectively suppresses an interfering wave.

As described with reference to FIG. 2, the output terminal of the FIR digital filter 207 at the final stage of the reception-based digital front-end unit 101 generates a reception-based digital base band signal at the sampling rate of 7.68 MHz frequency that is double the signal band of approximately 3.84 MHz for WCDMA-received base band signals based on HSDPA. The 3GPP-based WCDMA specifies the sampling rate of 7.68 MHz frequency for WCDMA-received base band signals based on HSDPA in the signal band of 3.84 MHz for WCDMA-received base band signals based on HSDPA. The sampling rate of 7.68 MHz frequency is double the signal band of 3.84 MHz that is double the signal band of 1.92 MHz for each of I-phase and Q-phase received base band signals.

The digital interface specification conforming to the DigRF v3 standard defines 312 Mbps as the maximum transfer rate for received base band signals. Normally, a transmission phase for transmission data is optimized using a clock signal four or eight times faster than the maximum transfer frequency of 312 MHz corresponding to the maximum transfer rate of 312 Mbps. An architecture of using a quad-speed clock signal is employed for the RFIC mounted on a mobile station that performs transmission and reception operations in multimode of WCDMA and GSM/EDGE shown in FIG. 1 according to the embodiment of the invention. The frequency of 1248 MHz, the quadruple of the maximum transfer frequency of 312 MHz, is used for the reference clock signal clk generated from the voltage-controlled oscillator (VCO) 214 and the PLL frequency synthesizer 213.

When the frequency of 7.68 MHz is directly generated from the 1248 MHz frequency for the reference clock signal clk so as to determine the sampling rate for HSDPA-based WCDMA-received base band signals supplied to the digital interface unit 105. The division is non-integral, i.e., 1248/7.68=162.5. The dividing ratio is not an integer.

To solve this problem, an interpolation section 203 is provided for the reception-based digital front-end unit 101 of the RFIC that performs transmission and reception operations in multimode of WCDMA and GSM/EDGE in FIG. 2 according to the embodiment of the invention.

FIGS. 5A and 5B show relation between an interpolation ratio and the other operation setting parameters in the interpolation section 203 of the reception-based digital front-end unit 101 of the RFIC that performs transmission and reception operations in multimode of WCDMA and GSM/EDGE in FIG. 2 according to the embodiment of the invention.

In FIG. 5A, a column 501 lists interpolation ratios for the interpolation section 203 and a column 502 lists required integral dividing ratios.

The first row in FIG. 5A shows that the interpolation ratio of 2 is assigned to the interpolation section 203. Multiplying three integral dividing ratios 5, 5, and 13 together can generate an integral dividing count of 325, i.e., the double of the non-integral dividing count of 162.5. Multiple dividing ratios are available by providing multiple decimation sections having integral decimation rates for the intermediate WCDMA signal processing section of the reception-based digital front-end unit 101 in FIG. 2, for example. An example shows the decimation sections 201 and 204 provided for the intermediate WCDMA signal processing section of the reception-based digital front-end unit 101.

For example, the sixth row in FIG. 5A shows that the interpolation ratio of 12 is assigned to the interpolation section 203. Multiplying five integral dividing ratios 2, 3, 5, 5, and 13 together can generate an integral dividing count of 1950, i.e., 12 times the non-integral dividing count of 162.5. As can be seen from the second to fifth rows in FIG. 5A, multiplying integral dividing ratios together can likewise generate an integral dividing count equivalent to an even-numbered multiple of the non-integral dividing count 162.5.

In FIG. 5B, a column 503 lists interpolation ratios for the interpolation section 203. A column 504 lists dividing ratios for the first divider DIV1 coupled to the oversampling ΔΣ analog-to-digital converter 102 and frequencies for the first frequency dividing clock signal CLK1 as output from the first divider DIV1.

The first row in FIG. 5B contains the interpolation ratio of 2 for the interpolation section 203 and shows three possibilities of using the frequency 1248 MHz for the reference clock signal clk. Firstly, the dividing ratio of 5 is multiplied by the frequency of 249.6 MHz to produce the frequency of 1248 MHz for the reference clock signal clk. The first frequency dividing clock signal CLK1 having the sampling frequency of 249.6 MHz is supplied to the oversampling ΔΣ analog-to-digital converter 102. Secondly, the dividing ratio of 13 is multiplied by the frequency of 96 MHz to produce the frequency of 1248 MHz for the reference clock signal clk. The first frequency dividing clock signal CLK1 having the sampling frequency of 96 MHz is supplied to the oversampling ΔΣ analog-to-digital converter 102. Thirdly, the dividing ratio of 25 is multiplied by the frequency of 49.92 MHz to produce the frequency of 1248 MHz for the reference clock signal clk. The first frequency dividing clock signal CLK1 having the sampling frequency of 49.92 MHz is supplied to the oversampling ΔΣ analog-to-digital converter 102.

As can be seen from the first to sixth rows in FIG. 5B, the frequency of 1248 MHz is available for the reference clock signal clk in many cases even when the interpolation ratio for the interpolation section 203 increases in the order of 4, 6, 8, 10, and 12.

It should be noted that the dividing ratio for the first divider DIV1 is set to 10 corresponding to the interpolation ratio of 4 for the interpolation section 203 on the second row in FIG. 5B. In this case, the first frequency dividing clock signal CLK1 with the sampling frequency of 124.8 MHz is supplied to the oversampling ΔΣ analog-to-digital converter 102.

As mentioned above with reference to FIG. 4, there may be a case of providing the S/N ratio of 50 dB or higher for the oversampling ΔΣ analog-to-digital converter 102. In such case, it is desirable to provide a frequency of approximately 100 MHz or higher for a sampling clock signal supplied to the ΔΣ analog-to-digital converter 102. A selection 505 on the second row in FIG. 5B corresponds to the sampling frequency of 100 MHz or higher. Accordingly, the selection 505 is recommended to increase the S/N ratio (SNR) for the oversampling ΔΣ analog-to-digital converter 102. The fourth and sixth rows in FIG. 5B also contain the other selections that correspond to the dividing ratio of 10 for the first divider DIV1 and the sampling frequency of 124.8 MHz. However, these selections each use a large interpolation ratio of 8 or 12 for the interpolation section 203. The selections may cause an adverse effect of increasing the circuit scale, chip footprint, or power consumption on the interpolation section 203 in the reception-based digital front-end unit 101 shown in FIG. 2.

The selection 505 on the second row in FIG. 5B may be optimal because it can decrease the circuit scale, chip footprint, or power consumption of the interpolation section 203 of the reception-based digital front-end unit 101 in FIG. 2. With reference to the reception-based digital front-end unit 101 in FIG. 2, the dividing ratio of the first divider DIV1 is set to 10. The interpolation ratio of the interpolation section 203 is set to 4. The first frequency dividing clock signal CLK1 with the 124.8 MHz sampling frequency is supplied to the oversampling ΔΣ analog-to-digital converter 102. The decimation rate of the decimation section 201 is set to 13. The decimation rate of the decimation section 204 is set to 5. As a result, the output terminal of the FIR digital filter 207 generates a reception-based digital base band signal at the sampling rate of the 7.68 MHz frequency that is double the WCDMA-received base band signal band based on HSDPA.

The 3GPP-based GSM/EDGE mode specifies the sampling rate of 0.54 MHz frequency for GSM/EDGE-received base band signals in the signal band of 270 kHz for GSM/EDGE-received base band signals. The sampling rate of 0.54 MHz frequency is double the signal band of approximately 270 kHz that is double the signal band of approximately 135 kHz for each of I-phase and Q-phase received base band signals.

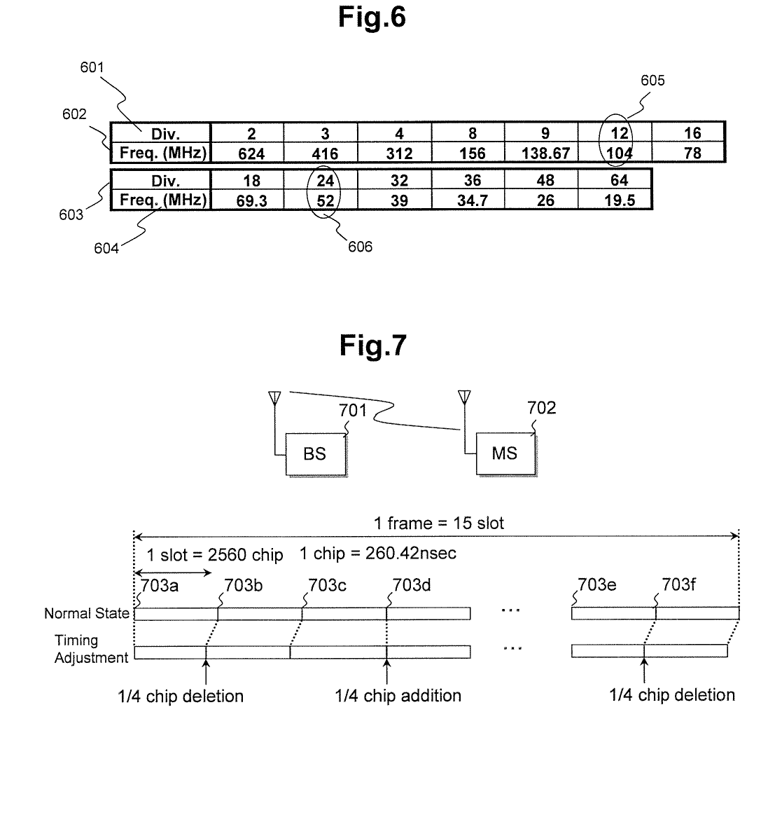

FIG. 6 shows relation between a dividing ratio of the second divider DIV2 and a frequency of the second frequency dividing clock signal CLK2 as output from the second divider DIV2 coupled to the oversampling ΔΣ analog-to-digital converter 102 of the reception-based digital front-end unit 101 of the RFIC that performs transmission and reception operations in multimode of WCDMA and GSM/EDGE in FIG. 2 according to the embodiment of the invention.

A first row 601 and a third row 603 in FIG. 6 describe dividing ratios for the second divider DIV2. A second row 602 and a fourth row 604 in FIG. 6 describe frequencies for the second frequency dividing clock signal CLK2 as output from the second divider DIV2.

A selection 605 in FIG. 6 signifies the following. The reference clock signal clk of the 1248 MHz frequency is divided by the dividing ratio of 12 for the second divider DIV2. The second frequency dividing clock signal CLK2 of the 104 MHz frequency is then generated from output of the second divider DIV2. The 104 MHz frequency of the second frequency dividing clock signal CLK2 from the second divider DIV2 approximates the frequency of 124.8 MHz of the first frequency dividing clock signal CLK1 from the first divider DIV1. Approximately the same circuit scale is therefore applied to the WCDMA signal processing section and the GSM/EDGE signal processing section at the center of the reception-based digital front-end unit 101 of the RFIC in FIG. 2. The two circuit blocks are appropriately symmetric to each other. The RFIC chip layout may be easily designed. From this viewpoint, the selection immediately before the selection 605 in FIG. 6 may be the second best. The reference clock signal clk of the 1248 MHz frequency is divided by the dividing ratio of 9 for the second divider DIV2. The second frequency dividing clock signal CLK2 of the 138.67 MHz frequency is generated from output of the second divider DIV2. With reference to the reception-based digital front-end unit 101 in FIG. 2, the dividing ratio of the second divider DIV2 is set to 12. The second frequency dividing clock signal CLK2 with the 104 MHz sampling frequency is supplied to the oversampling ΔΣ analog-to-digital converter 102. The decimation rate of the decimation section 202 is set to 12. The decimation rate of each of the decimation sections 208 and 209 is set to 4. As a result, the output terminal of the FIR digital filter 212 generates a reception-based digital base band signal at the sampling rate of the 0.54 MHz frequency that is approximately double the GSM/EDGE-received base band signal band.

Another selection 606 in FIG. 6 signifies the following. The reference clock signal clk of the 1248 MHz frequency is divided by the dividing ratio of 24 for the second divider DIV2. The second frequency dividing clock signal CLK2 of the 52 MHz frequency is then generated from output of the second divider DIV2. The selection 606 allows the use of the second frequency dividing clock signal CLK2 having the frequency half that provided by the selection 605. The selection 606 can reduce power consumption of the ΔΣ analog-to-digital converter 102 and the GSM/EDGE signal processing section at the center of the reception-based digital front-end unit 101.

<Time Adjustment According to WCDMA>

FIG. 7 illustrates time adjustment requisite for a WCDMA communication system.

As shown at the bottom of FIG. 7, one chip is equivalent to the signal time unit of 260.42 nsec. One slot of 666.7 μsec contains 2560 chips. One frame of 10 msec contains 15 slots.

As shown at the top of FIG. 7, the WCDMA standard requires a function of sliding the transmission timing from an antenna at the accuracy of a ¼-chip or smaller so as to cancel a signal transmission delay variation between a base station (BS) 701 and a mobile station (MS) 702. The ¼-chip is added or deleted at boundaries 703b, 703d, and 703f between transmission signal slots. The time adjustment is performed on a transmission-based D/A converter or a digital filter as an input portion thereof in any of the base station (BS) 701 and the mobile station (MS) 702. The WCDMA standard specifies the time adjustment interval as not only ¼-chip but also smaller step widths. The time adjustment may be performed in ⅕-chip or ⅙-chip step widths.

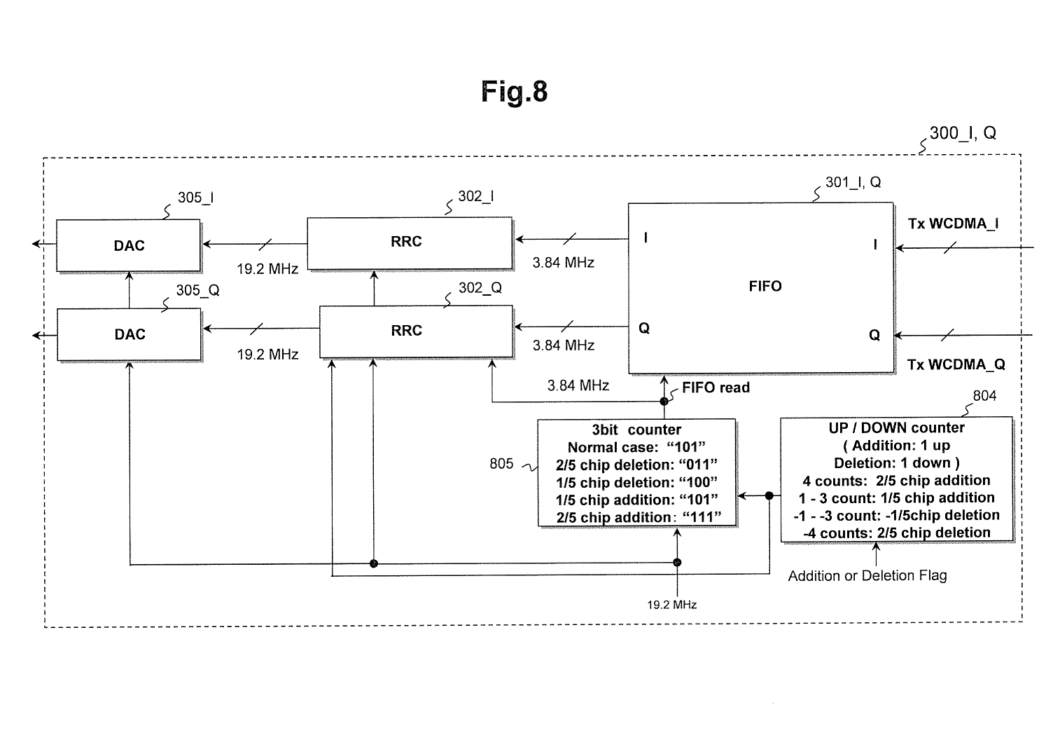

FIG. 8 shows the configuration of the transmission-based digital front-end unit 300 capable of time adjustment for WCDMA communication in the RFIC as shown in FIGS. 1 and 3 according to the embodiment of the invention.

Similarly to FIGS. 1 and 3, the transmission-based digital front-end unit 300 shown in FIG. 8 also includes the transmission FIFO memory 301, the FIR digital filters 302_I and 302_Q as root raised cosine (RRC) filters, and the D/A converters 305_I and 305_Q.

As mentioned above with reference to FIG. 4, the PLL frequency synthesizer 213 and the voltage-controlled oscillator (VCO) 214 generate the reference clock signal clk of the 1248 MHz frequency. Dividing the 1248 MHz frequency for the reference clock signal clk by 325 generates the 3.84 MHz frequency for the signal band of WCDMA-transmitted base band signals according to HSUPA as high-speed data transfer. The 15.36 MHz frequency is four times the 3.84 MHz frequency for the signal band of WCDMA-transmitted base band signals according to HSUPA. To generate the 15.36 MHz frequency, the 1248 MHz frequency needs to be divided by 81.25, a non-integer value. Actually, this is very difficult. To solve this problem, the 1248 MHz frequency for the reference clock signal clk is divided by 65 as an integer to generate the 19.2 MHz frequency that is five times the signal band of WCDMA-transmitted base band signals according to HSUPA. As shown in FIGS. 3 and 8, an operating clock signal of the 19.2 MHz frequency is supplied to the FIR digital filters 302_I and 302_Q as root raised cosine (RRC) filters and the D/A converters 305_I and 305_Q.

For the above-mentioned reason, the FIR digital filters 302_I and 302_Q and the D/A converters 305_I and 305_Q are supplied with the operating clock signal of the 19.2 MHz frequency that is five times the signal band of WCDMA-transmitted base band signals according to HSUPA. The RFIC according to the embodiment of the invention as shown in FIGS. 1 and 3 includes the transmission-based digital front-end unit 300 in FIG. 8 and uses the time adjustment of addition and deletion based on the ⅕-chip step width. The ⅕-chip time is equivalent to 52.08 nsec because the one chip time is equivalent to 260.42 nsec. The ⅕-chip time may be converted into frequency f=1/T=1/52.08 nsec=19.2 MHz. This matches the frequency of the operating clock signal, i.e., the 19.2 MHz frequency that is five times the signal band of WCDMA-transmitted base band signals according to HSUPA.

The base band LSI can operate on the 15.36 MHz frequency that is four times the signal band of WCDMA-transmitted base band signals according to HSUPA. The base band LSI can use the time adjustment of addition and deletion based on the ¼-chip step width. The ¼-chip time is equivalent to 65.10 nsec because the one chip time is equivalent to 260.42 nsec. The ¼-chip time may be converted into frequency f=1/T=1/65.10 nsec=15.36 MHz. This matches the frequency of the operating clock signal, i.e., the 15.36 MHz frequency that is four times the signal band of WCDMA-transmitted base band signals according to HSUPA.

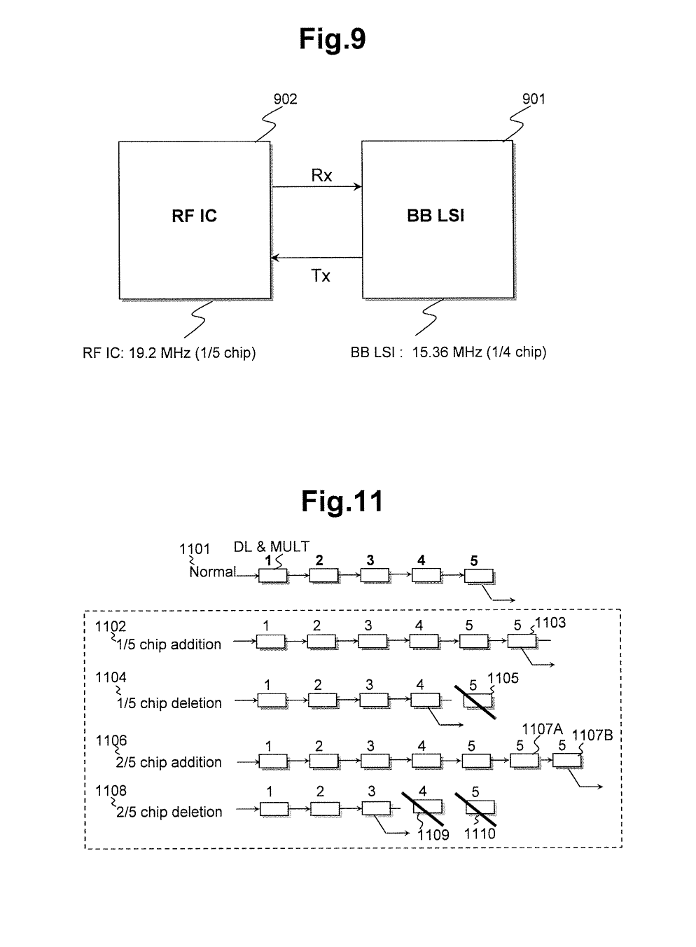

FIG. 9 illustrates coupling between a base band LSI (901) and an RFIC (902), the base band LSI being used for time adjustment of addition and deletion based on a ¼-chip step width and the RFIC being used for time adjustment of addition and deletion based on a ⅕-chip step width.

During a WCDMA transmission operation on the multimode mobile station as shown in FIG. 9, a base band LSI 901 supplies an RFIC 902 with a WCDMA transmission-based digital base band signal Tx according to HSUPA.

To simply compare operation speeds, the base band LSI 901 operates on a low-speed clock of 15.36 MHz and uses the time adjustment of ¼-chip addition for long-time delayed buffering of large-volume data. By contrast, the RFIC 902 operates on a high-speed clock of 19.2 MHz and uses the time adjustment of ⅕-chip addition for short-time delayed buffering of small-volume data. When such situation continues, the transmission FIFO memory 301 as shown in FIGS. 1, 3, and 8 runs out of storage space, causing a data overflow. There may be a loss of data transmitted from the multimode mobile station to the base station.

To solve this problem, an up-down counter 804 is included in the transmission-based digital front-end units 300_I and 300_Q as shown in FIGS. 1 and 8.

The up-down counter 804 is supplied with flag information about chip addition and deletion from the base band LSI via the digital interface unit 105. The up-down counter 804 counts the number of ⅕-chip insertions and deletions. The count is incremented by one each time the ⅕-chip is added. The count is decremented by one each time the ⅕-chip is deleted. More specifically, the count is simply incremented by one from the first to third ⅕-chip additions. The time adjustment is performed by adding every ⅕-chip based on the step width of 52.08 nsec. At the fourth ⅕-chip addition, however, the count is incremented by two. The time adjustment is accordingly performed by adding every ⅖-chips based on the step width of 104.16 nsec. As a result, the first to fourth ⅕-chip additions perform the time adjustment of adding one chip of 260.4 nsec. Meantime, the base band LSI adds the ¼-chip four times based on the step width of 65.10 nsec to perform the time adjustment of adding 260.4 nsec equivalent to one chip. It is possible to cancel a difference between step widths for the time adjustment on the base band LSI and the RFIC. Transmission data can be prevented from being overflowed in the transmission FIFO memory 301 of the RFIC. The up-down counter 804 returns to zero after the time adjustment of adding the 260.4 nsec time equivalent to one chip in response to addition of the fourth ⅕-chip.

The count is simply decremented by one in response to the first to third ⅕-chip deletions. The count is decremented by two in response to the fourth ⅕-chip deletion. A difference between step widths can be canceled likewise.

<Root Raised Cosine Filter>

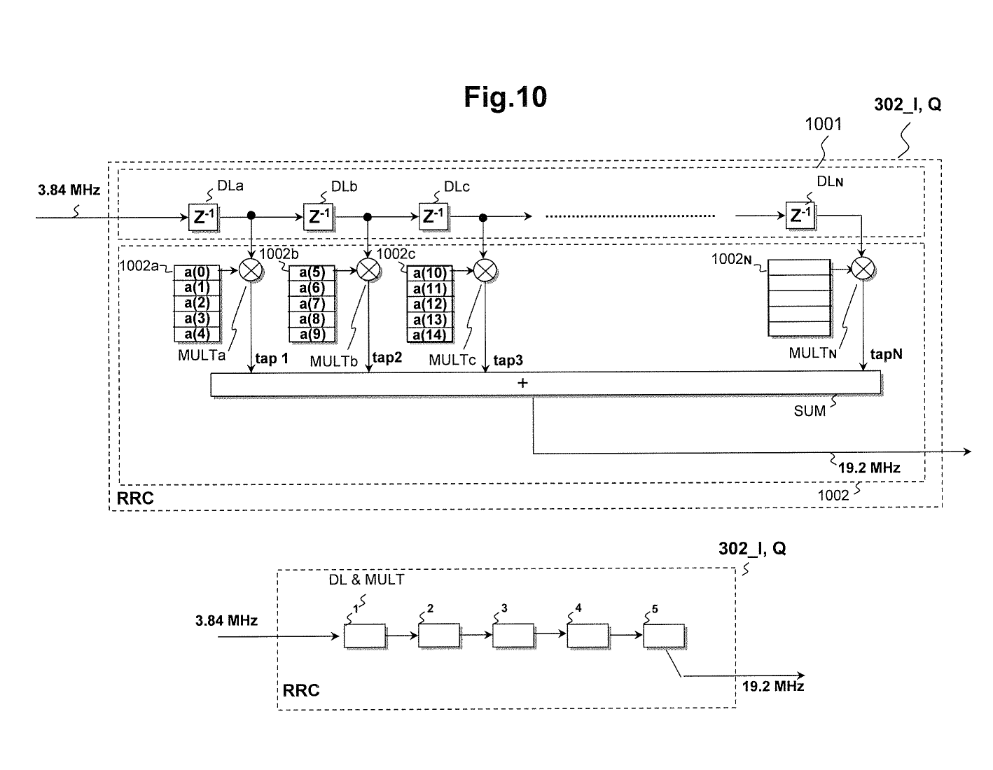

FIG. 10 shows the configuration of the FIR digital filters 302_I and 302_Q functioning as a root raised cosine (RRC) filters shown in FIGS. 3 and 8.

As shown in the top of FIG. 10, the FIR digital filter 302 includes a shifter 1001 further including multiple sample delay devices DLa, DLb, . . . , and DL_{N} that are supplied with a WCDMA transmission-based digital base band signal of the 3.84 MHz signal band according to HSUPA and are dependently coupled to each other. Furthermore, the FIR digital filter 302 includes a product-sum operation device 1002 supplied with a base band signal from an intermediate tap between the sample delay devices DLa, DLb, . . . , and DL_{N} of the shifter 1001. An output signal from the first sample delay device DLa of the shifter 1001 is supplied to one input terminal of a first multiplier MULTa in the product-sum operation device 1002. The other input terminal of the first multiplier MULTa is supplied with one coefficient selected from coefficients a(0), a(1), a(2), a(3), and a(4) stored in a first coefficient register 1002a. An output signal from the first multiplier MULTa is supplied to a first input terminal of an adder SUM. The subsequent configuration is similar. An output signal from the Nth sample delay device DL_{N} of the shifter 1001 is supplied to one input terminal of a first multiplier MULT_{N} in the product-sum operation device 1002. The other input terminal of the Nth multiplier MULT_{N} is supplied with one coefficient selected from coefficients stored in an Nth coefficient register 1002_{N}. An output signal from the first multiplier MULTa is supplied to an Nth input terminal of the adder SUM.

As shown in the bottom part of FIG. 10, the FIR digital filter 302 contains five sample delay device DLs and five multiplier MULTs. The bottom part of FIG. 10 omits the adder SUM for simplicity because no flag information about the chip addition or deletion is supplied for the time adjustment. In this state, the FIR digital filter 302 functions as the interpolation section 306 and the root raised cosine (RRC) filter 302. The FIR digital filter 302 is supplied with a WCDMA-transmitted base band signal according to HSUPA in the signal band of the 3.84 MHz frequency and outputs a signal band frequency of 19.2 MHz, five times the signal band of the 3.84 MHz frequency.

However, the number of sample delay devices DL and multipliers MULT coupled changes when the FIR digital filter 302 is supplied with the flag information about chip addition or deletion for the time adjustment.

FIG. 11 shows how the configuration of the FIR digital filter 302 in FIG. 10 functioning as a root raised cosine (RRC) filter varies with flag information about chip addition or deletion for the time adjustment.

The top part of FIG. 11 shows a normal state 1101 in which five sample delay devices DL and five multipliers MULT are coupled to each other. In this state, the FIR digital filter 302 is supplied with no flag information about chip addition or deletion for the time adjustment.

Below the normal state, there are shown various states in which the FIR digital filter 302 is supplied with the flag information about chip addition or deletion for the time adjustment.

The first state 1102 corresponds to the ⅕-chip addition and increases the number of sample delay devices DL and multipliers MULT from five to six each inside the FIR digital filter 302. In the state 1102, a process 1103 is used as the sixth operation result using the fifth sample delay device, the fifth coefficient register, and the fifth multiplier. It is possible to avoid an unwanted variation in the transmission signal.

The second state 1104 corresponds to the ⅕-chip deletion and decreases the number of sample delay devices DL and multipliers MULT from five to four each inside the FIR digital filter 302. The state 1104 omits a multiplication process 1105 using the fifth sample delay device, the fifth coefficient register, and the fifth multiplier while the multiplication process 1105 should have been originally available as the fifth process.

The third state 1106 corresponds to the ⅖-chip addition and increases the number of sample delay devices DL and multipliers MULT from five to seven each inside the FIR digital filter 302. In the state 1106, processes 1107A and 1107B are used as the sixth and seventh operation results using the fifth sample delay device, the fifth coefficient register, and the fifth multiplier. It is also possible to avoid an unwanted variation in the transmission signal.

Finally, the fourth state 1108 corresponds to the ⅖-chip deletion and decreases the number of sample delay devices DL and multipliers MULT from five to three each inside the FIR digital filter 302. The state 1108 omits a multiplication process 1109 using the fourth sample delay device, the fourth coefficient register, and the fourth multiplier and a multiplication process 1110 using the fifth sample delay device, the fifth coefficient register, and the fifth multiplier while the multiplication process 1109 should have been originally available as the fourth process and the multiplication process 1110 should have been originally available as the fifth process.

As mentioned above with reference to FIG. 11, the configuration of the FIR digital filter 302 in FIG. 10 functioning as a root raised cosine (RRC) filter varies with the flag information about the chip addition or deletion for the time adjustment. Accordingly, the transmission-based digital front-end unit 300 in FIG. 8 includes a 3-bit counter 805 so as to be capable of the time adjustment for WCDMA communication in the RFIC according to the embodiment of the invention. A counter value of the up-down counter 804 controls a counter value of the 3-bit counter 805. The 3-bit counter 805 provides up to eight types of counter values. The use of these counter values can change the number of sample delay devices DL and multipliers MULT coupled in the FIR digital filter 302.

<PLL Frequency Synthesizer and Voltage-Controlled Oscillator>

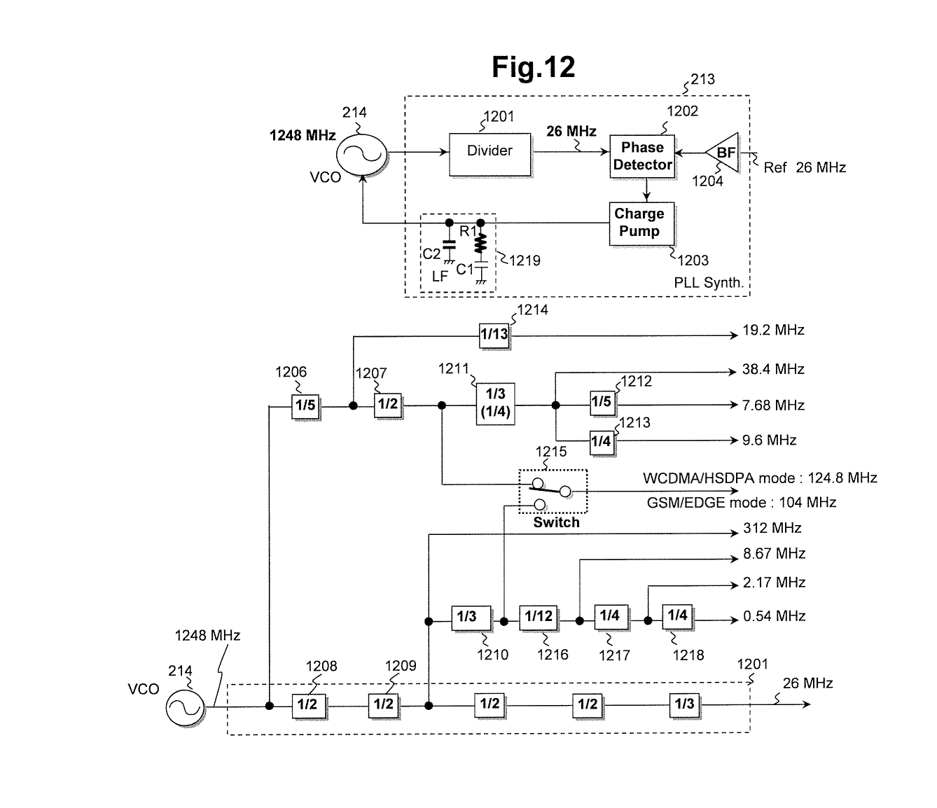

FIG. 12 shows the configuration of the PLL frequency synthesizer 213 and the voltage-controlled oscillator (VCO) 214 used for the RFIC mounted on a mobile station that performs transmission and reception operations in multimode of WCDMA and GSM/EDGE as shown in FIGS. 1, 2, and 3 according to the embodiment of the invention.

As shown in the top part of FIG. 12, the PLL frequency synthesizer 213 is coupled to an oscillation control input terminal of the voltage-controlled oscillator (VCO) 214. The PLL frequency synthesizer 213 includes a buffer amplifier 1204, a divider 1201, a phase comparator 1202, a charge pump 1203, and a loop filter 1219.

One input terminal of the phase comparator 1202 is supplied with the reference clock of the 26 MHz frequency via the buffer amplifier 1204. The reference clock is used for a system clock signal (SysClk) compliant with the digital interface specification. The other input terminal of the phase comparator 1202 is supplied with an output signal from the divider 1201 having the dividing ratio of 48. An output signal from the phase comparator 1202 is supplied to an input terminal of the charge pump 1203. An output signal from the charge pump 1203 passes through the loop filter 1219 and is supplied to an oscillation control input terminal of the voltage-controlled oscillator (VCO) 214. An output signal from the voltage-controlled oscillator (VCO) 214 has the 1248 MHz frequency. The output signal is converted by the divider 1201 having the dividing ratio of 48 into a negative return signal having the 26 MHz frequency and returns to the other input terminal of the phase comparator 1202.

The bottom part of FIG. 12 shows the configuration of a circuit for generating signals of various frequencies from the output signal of the 1248 MHz frequency generated from the voltage-controlled oscillator (VCO) 214.

The signal of the 19.2 MHz frequency is used for the D/A converter 305 and the interpolation section 306 of the transmission-based digital front-end unit 300 shown in FIG. 3. The signal can be generated by dividers 1206 and 1214. The divider 1206 has the dividing ratio of 5. The divider 1214 has the dividing ratio of 13.

The signal of the 38.4 MHz frequency is used for the CIC digital filter 206 of the reception-based digital front-end unit 101 shown in FIG. 2. The signal can be generated by the dividers 1206, 1207, and 1211. The divider 1206 has the dividing ratio of 5. The divider 1207 has the dividing ratio of 2. The non-integral divider 1211 has the average dividing ratio of 3.25 that varies between dividing ratios 3 and 4.

The signal of the 7.68 MHz frequency is used for the FIR digital filter 207 as a digital equalizer filter of the reception-based digital front-end unit 101 shown in FIG. 2. The signal can be generated by the dividers 1206, 1207, 1211, and 1212. The divider 1206 has the dividing ratio of 5. The divider 1207 has the dividing ratio of 2. The non-integral divider 1211 has the average dividing ratio of 3.25 that varies between dividing ratios 3 and 4. The divider 1212 has the dividing ratio of 5.

The signal of the 9.6 MHz frequency is used for the FIR digital filter 205 as a root raised cosine (RRC) filter of the reception-based digital front-end unit 101 shown in FIG. 2. The signal can be generated by a divider 1213 having the dividing ratio of 4. The divider 1213 is coupled to the non-integral divider 1211 having the average dividing ratio of 3.25.

The first frequency dividing clock signal CLK1 is supplied to the oversampling ΔΣ analog-to-digital converter 102 of the reception-based digital front-end unit 101 shown in FIG. 2 during the WCDMA reception. The signal can be generated by the dividers 1206 and 1207, and a switch 1215. The divider 1206 has the dividing ratio of 5. The divider 1207 has the dividing ratio of 2.

The signal of the 312 MHz frequency is used for the digital interface unit 105 shown in FIG. 1. The signal can be generated by dividers 1208 and 1209. The divider 1208 has the dividing ratio of 2. The divider 1209 has the dividing ratio of 2.

The second frequency dividing clock signal CLK2 of the 104 MHz frequency is supplied to the oversampling ΔΣ analog-to-digital converter 102 of the reception-based digital front-end unit 101 shown in FIG. 2 during the GSM/EDGE reception. The signal can be generated by the dividers 1208, 1209, and 1210, and the switch 1215. The divider 1208 has the dividing ratio of 2. The divider 1209 has the dividing ratio of 2. The divider 1210 has the dividing ratio of 3.

The clock signal of the 8.67 MHz frequency is supplied to the FIR digital filter 210 as a decimation filter for alias signal removal of the reception-based digital front-end unit 101 shown in FIG. 2. The clock signal can be generated by a divider 1216 having the dividing ratio of 12. The divider 1216 is coupled to the output of the divider 1210 having the dividing ratio of 3.

The clock signal of the 2.17 MHz frequency is supplied to the FIR digital filter 210 as a decimation filter for alias signal removal of the reception-based digital front-end unit 101 shown in FIG. 2. The clock signal can be generated by a divider 1217 having the dividing ratio of 4. The divider 1217 is coupled to the output of the divider 1216 having the dividing ratio of 12.

The signal of the 0.54 MHz frequency is used for the FIR digital filter 212 as a digital equalizer filter of the reception-based digital front-end unit 101 shown in FIG. 2. The signal can be generated by a divider 1218 having the dividing ratio of 4. The divider 1218 is coupled to the output of the divider 1217 having the dividing ratio of 4.

While there have been described specific preferred embodiments of the present invention, it is to be distinctly understood that the present invention is not limited thereto but may be otherwise variously embodied within the spirit and scope of the invention.

For example, the reception-based analog front-end unit 10 may use a low noise amplifier and a reception mixer independently for each of a WCDMA-received RF signal and a GSM/EDGE-received RF signal to down-convert the signals into a reception-based analog base band signal in terms of frequencies.

For example, the RFIC may be used for reception of a 2 GHz frequency wireless LAN and a 5 GHz frequency wireless LAN. The invention is applicable even when a signal band for base band signals received on the 2 GHz wireless LAN differs from that for base band signals received on the 5 GHz wireless LAN.

What is claimed is:

1. A semiconductor integrated circuit comprising:
a reception-based analog front-end unit;
a reception-based digital front-end unit; and
a digital interface unit,
wherein the reception-based analog front-end unit functions as a receiver for down-converting an RF reception signal into a reception-based analog base band signal, the RF reception signal being received at an antenna mounted on a communication terminal,
wherein the reception-based digital front-end unit comprises an analog-to-digital converter and a reception-based digital filter unit,
wherein the analog-to-digital converter converts the reception-based analog base band signal supplied from an output of the reception-based analog front-end unit into a reception-based digital base band signal,
wherein the reception-based digital base band signal from the analog-to-digital converter is transmitted to the digital interface unit via the reception-based digital filter unit,
wherein the digital interface unit is capable of supplying an external digital base band processing unit with the reception-based digital base band signal transmitted from the reception-based digital filter unit,
wherein the reception-based analog front-end unit is capable of down-converting a first RF reception signal according to a first communication system and a second RF reception signal according to a second communication system received at the antenna into a first reception-based analog base band signal having a first signal band and a second reception-based analog base band signal having a second signal band narrower than the first signal band, respectively,
wherein the analog-to-digital converter of the reception-based digital front-end unit comprises an oversampling analog-to-digital converter,
wherein the oversampling analog-to-digital converter is capable of converting the first reception-based analog base band signal and the second reception-based analog base band signal supplied from the reception-based analog front-end unit into a first reception-based digital base band signal and a second reception-based digital base band signal, respectively,
wherein the reception-based digital filter unit of the reception-based digital front-end unit comprises a first digital filter coupled to an output of the oversampling analog-to-digital converter,
wherein the first digital filter is capable being used for a decimation process on the first reception-based digital base band signal supplied from the oversampling analog-to-digital converter and a decimation process on the second reception-based digital base band signal supplied from the oversampling analog-to-digital converter in common with each other,
wherein the reception-based digital filter unit further comprises a second digital filter and a third digital filter parallel coupled between an output of the first digital filter and the digital interface unit,
wherein the second digital filter down-samples the first reception-based digital base band signal, based on the first communication system, from the output of the first digital filter and thereby supplies the digital interface unit with the first reception-based digital base band signal having a first sampling rate, and
wherein the third digital filter down-samples the second reception-based digital base band signal, based on the second communication system, from the output of the first digital filter and thereby supplies the digital interface unit with the second reception-based digital base band signal having a second sampling rate smaller than the first sampling rate.

2. The semiconductor integrated circuit according to claim 1,
wherein the second digital filter generates the first reception-based digital base band signal having the first sampling rate,
wherein the third digital filter generates the second reception-based digital base band signal having the second sampling rate, and
wherein the second digital filter and the third digital filter are provided with a down-sampling rate conversion ratio difference equivalent to a difference between the first signal band for the first reception-based analog base band signal and the second signal band for the second reception-based analog base band signal.

3. The semiconductor integrated circuit according to claim 2,
wherein the second digital filter comprises an interpolation section having an interpolation ratio assigned a specified value, and
wherein the specified value of the interpolation ratio generates the down-sampling rate conversion ratio difference.

4. The semiconductor integrated circuit according to claim 1,
wherein the reception-based digital front-end unit further comprises a reception memory buffer that temporarily stores the reception-based digital base band signal processed by the reception-based digital filter unit and then supplies the signal to the digital interface unit.

5. The semiconductor integrated circuit according to claim 4,
wherein the second digital filter comprises a first root raised cosine filter for reducing an inter-decoding interference.

6. The semiconductor integrated circuit according to claim 5,
wherein the reception-based analog front-end unit and the reception-based digital front-end unit process the first RF reception signal according to a WCDMA communication system as the first communication system and the second RF reception signal according to a GSM/EDGE communication system as the second communication system.

7. The semiconductor integrated circuit according to claim 4, further comprising:
a transmission-based digital front-end unit; and
a transmission-based analog front-end unit,
wherein the digital interface unit is capable of supplying the transmission-based digital front-end unit with a transmission-based digital base band signal transmitted from an outside digital base band processing unit,
wherein the transmission-based digital front-end unit comprises a transmission-based digital filter unit and a D/A converter,
wherein the transmission-based digital filter unit transmits the transmission-based digital base band signal supplied from the digital interface unit to the D/A converter,
wherein the D/A converter converts the transmission-based digital base band signal supplied from an output of the transmission-based digital filter unit into a transmission-based analog base band signal, and
wherein the transmission-based analog front-end unit functions as a transmitter that up-converts the transmission-based analog base band signal from an output of the D/A converter into an RF transmission signal.

8. The semiconductor integrated circuit according to claim 7,
wherein the transmission-based digital filter unit comprises a fourth digital filter and a fifth digital filter parallel coupled between the digital interface unit and an input of the D/A converter,
wherein the fourth digital filter up-samples a first transmission-based digital base band signal, based on the first communication system, supplied from the digital interface unit and thereby supplies the input of the D/A converter with the first transmission-based digital base band signal having a third sampling rate, and
wherein the fifth digital filter up-samples a second transmission-based digital base band signal, based on the second communication system, supplied from the digital interface unit and thereby supplies the input of the D/A converter with the second transmission-based digital base band signal having a fourth sampling rate.

9. The semiconductor integrated circuit according to claim 7,
wherein the transmission-based digital front-end unit further comprises a transmission buffer memory that temporarily stores transmission-based digital base band signal transmitted from the outside digital base band processing unit and then supplies the signal to the transmission-based digital filter unit.

10. The semiconductor integrated circuit according to claim 9,
wherein the fourth digital filter comprises a second root raised cosine filter for reducing an inter-decoding interference.

11. An operation method of a semiconductor integrated circuit comprising a reception-based analog front-end unit, a reception-based digital front-end unit, and a digital interface unit,
wherein the reception-based analog front-end unit functions as a receiver for down-converting an RF reception signal into a reception-based analog base band signal, the RF reception signal being received at an antenna mounted on a communication terminal,
wherein the reception-based digital front-end unit comprises an analog-to-digital converter and a reception-based digital filter unit,
wherein the analog-to-digital converter converts the reception-based analog base band signal supplied from an output of the reception-based analog front-end unit into a reception-based digital base band signal,
wherein the reception-based digital base band signal from the analog-to-digital converter is transmitted to the digital interface unit via the reception-based digital filter unit,
wherein the digital interface unit is capable of supplying an external digital base band processing unit with the reception-based digital base band signal transmitted from the reception-based digital filter unit,
wherein the reception-based analog front-end unit is capable of down-converting a first RF reception signal according to a first communication system and a second RF reception signal according to a second communication system received at the antenna into a first reception-based analog base band signal having a first signal band and a second reception-based analog base band signal having a second signal band narrower than the first signal band, respectively,
wherein the analog-to-digital converter of the reception-based digital front-end unit comprises an oversampling analog-to-digital converter,
wherein the oversampling analog-to-digital converter is capable of converting the first reception-based analog base band signal and the second reception-based analog base band signal supplied from the reception-based analog front-end unit into a first reception-based digital base band signal and a second reception-based digital base band signal, respectively,
wherein the reception-based digital filter unit of the reception-based digital front-end unit comprises a first digital filter coupled to an output of the oversampling analog-to-digital converter,
wherein the first digital filter is capable of being used for a decimation process on the first reception-based digital base band signal supplied from the oversampling analog-to-digital converter and a decimation process on the second reception-based digital base band signal supplied from the oversampling analog-to-digital converter in common with each other,
wherein the reception-based digital filter unit further comprises a second digital filter and a third digital filter parallel coupled between an output of the first digital filter and the digital interface unit,
wherein the second digital filter down-samples the first reception-based digital base band signal, based on the first communication system, from the output of the first digital filter and thereby supplies the digital interface unit with the first reception-based digital base band signal having a first sampling rate, and
wherein the third digital filter down-samples the second reception-based digital base band signal, based on the second communication system, from the output of the first digital filter and thereby supplies the digital interface unit with the second reception-based digital base band signal having a second sampling rate smaller than the first sampling rate.

12. The operation method of the semiconductor integrated circuit according to claim 11,
wherein the second digital filter generates the first reception-based digital base band signal having the first sampling rate,
wherein the third digital filter generates the second reception-based digital base band signal having the second sampling rate, and
wherein the second digital filter and the third digital filter are provided with a down-sampling rate conversion ratio difference equivalent to a difference between the first signal band for the first reception-based analog base band signal and the second signal band for the second reception-based analog base band signal.

13. The operation method of the semiconductor integrated circuit according to claim 12,
wherein the second digital filter comprises an interpolation section having an interpolation ratio assigned a specified value, and
wherein the specified value of the interpolation ratio generates the down-sampling rate conversion ratio difference.

14. The operation method of the semiconductor integrated circuit according to claim 11,
wherein the reception-based digital front-end unit further comprises a reception memory buffer that temporarily stores the reception-based digital base band signal processed by the reception-based digital filter unit and then supplies the signal to the digital interface unit.

15. The operation method of the semiconductor integrated circuit according to claim 14,
wherein the second digital filter comprises a first root raised cosine filter for reducing an inter-decoding interference.

16. The operation method of the semiconductor integrated circuit according to claim 15,
wherein the reception-based analog front-end unit and the reception-based digital front-end unit process the first RF reception signal according to a WCDMA communication system as the first communication system and the second RF reception signal according to a GSM/EDGE communication system as the second communication system.

17. The operation method of the semiconductor integrated circuit according to claim 14,
wherein the semiconductor integrated circuit further comprises a transmission-based digital front-end unit and a transmission-based analog front-end unit,
wherein the digital interface unit is capable of supplying the transmission-based digital front-end unit with a transmission-based digital base band signal transmitted from an outside digital base band processing unit,
wherein the transmission-based digital front-end unit comprises a transmission-based digital filter unit and a D/A converter,
wherein the transmission-based digital filter unit transmits the transmission-based digital base band signal supplied from the digital interface unit to the D/A converter,
wherein the D/A converter converts the transmission-based digital base band signal supplied from an output of the transmission-based digital filter unit into a transmission-based analog base band signal, and
wherein the transmission-based analog front-end unit functions as a transmitter that up-converts the transmission-based analog base band signal from an output of the D/A converter into an RF transmission signal.

18. The operation method of the semiconductor integrated circuit according to claim 17,
wherein the transmission-based digital filter unit comprises a fourth digital filter and a fifth digital filter parallel coupled between the digital interface unit and an input of the D/A converter,
wherein the fourth digital filter up-samples a first transmission-based digital base band signal, based on the first communication system, supplied from the digital interface unit and thereby supplies the input of the D/A converter with the first transmission-based digital base band signal having a third sampling rate, and
wherein the fifth digital filter up-samples a second transmission-based digital base band signal, based on the second communication system, supplied from the digital interface unit and thereby supplies the input of the D/A converter with the second transmission-based digital base band signal having a fourth sampling rate.

19. The operation method of the semiconductor integrated circuit according to claim 17,
wherein the transmission-based digital front-end unit further comprises a transmission buffer memory that temporarily stores the transmission-based digital base band signal transmitted from the outside digital base band processing unit and then supplies the signal to the transmission-based digital filter unit.

20. The operation method of the semiconductor integrated circuit according to claim 19,
wherein the fourth digital filter comprises a second root raised cosine filter for reducing an inter-decoding interference.
